(19) United States
(12) Patent Application Publication
(10) Pub. No.: US 2016/0191837 A1
(43) Pub. Date: Jun. 30, 2016

(54) DISPLAY APPARATUS AND DISPLAY METHOD

(71) Applicant: SAMSUNG ELECTRONICS CO., LTD., Suwon-si (KR)

(72) Inventors: Jae-young HUH, Seoul (KR); Yong-Ho KIM, Seoul (KR); Jin RA, Suwon-si (KR); Jong-hyun RYU, Suwon-si (KR); Ae-young LIM, Yongin-si (KR); Kyung-ho JEONG, Seoul (KR)

(73) Assignee: SAMSUNG ELECTRONICS CO., LTD., Suwon-si (KR)

(21) Appl. No.: 14/837,185

(22) Filed: Aug. 27, 2015

Related U.S. Application Data
(60) Provisional application No. 62/097,223, filed on Dec. 29, 2014.

(30) Foreign Application Priority Data
Jan. 30, 2015 (KR) 10-2015-0014774
Apr. 10, 2015 (KR) 10-2015-0050731

(51) Int. Cl. H04N 5/44; H04N 5/445; G06F 3/0488; G06F 3/0481; G06F 3/0484

(52) U.S. Cl. CPC H04N 5/4403; G06F 3/04817; G06F 3/04842; G06F 3/04886; H04N 5/44591; G06F 2203/04803

(57) ABSTRACT

A display apparatus is disclosed. The display apparatus includes: a flexible display configured to include a main region which is concavely bent, a first sub-region extended from the main region and convexly bent to a first side surface of the display apparatus, and a second sub-region extended from the main region and convexly bent to a second side surface of the display apparatus; and a controller configured to control the flexible display so that a user interface (UI) element corresponding to a specific event is displayed on at least one of the first sub-region, and the second sub-region, when the specific event occurs.

### CROSS-REFERENCE TO RELATED APPLICATIONS

This application claims priority from Korean Patent Application No. 10-2015-0050731, filed on Apr. 10, 2015, in the Korean Intellectual Property Office (KIPO), Korean Patent Application No. 10-2015-0014774, filed on Jan. 30, 2015, in the KIPO, and the benefit of U.S. Provisional Application No. 62/097,223, filed on Dec. 29, 2014 in the United States Patent and Trademark Office, the disclosures of which are incorporated herein by reference in their entireties.

### BACKGROUND

1. Field

Apparatuses and methods consistent with exemplary embodiments of the present disclosure relate to a display apparatus and a display method, and more particularly, to a display apparatus and a display method capable of displaying user interface (UI) elements on a sub-region formed in a case in which a flexible display is bent.

2. Description of the Related Art

In accordance with the development of an information-oriented society, demands for display apparatuses have increased, and according to the above-mentioned trend, various display apparatuses, such as a liquid crystal display (LCD) device, a plasma display panel (PDP), an electro luminescent display (ELD), a vacuum fluorescent display (VFD), and the like, have been recently developed.

A flexible display apparatus, which is not damaged even in a case in which the display apparatus is folded or rolled has emerged as a new technology in the field of displays. Currently, there are various obstacles in implementing a flexible display apparatus, but in accordance with the technology development, a thin film transistor liquid crystal display (LCD), an organic light emitting diodes (OLED), an electrophoretic, and the like have been targeted.

Recently, there has been a suggestion for a display having a curved structure. The curved structure is thought to improve a viewing angle and maximize the image quality because the edges of both sides of the display are bent toward the viewer.

In addition, there has been a suggestion for a curved display in which the curvature can be selectively changed. For example, the screen is in a curved state during playback of contents, such as a movie, and the screen changes to a flat state while the user surfs the the Internet.

However, the above-mentioned flexible display always displays the same screen regardless of the state of the display. In other words, the above-mentioned flexible display does not optimize the screen according to the state of the display.

### SUMMARY OF THE DISCLOSURE

Exemplary embodiments of the present disclosure overcome the above disadvantages and other disadvantages not described above. Also, the present exemplary embodiments are not required to overcome the disadvantages described above, and an exemplary embodiment of the present disclosure may not overcome any of the problems described above.

Aspects of the exemplary embodiments provide a display apparatus and a display method capable of displaying user interface (UI) elements on a sub-region formed in a case in which a flexible display unit is bent.

According to an aspect of an exemplary embodiment, there is provided a display apparatus includes: a flexible display configured to be concavely bent and including a main region, a first sub-region adjacent to a first side of the main region, and a second sub-region adjacent to a second side of the main region; and a controller configured to control the flexible display to display a user interface (UI) element corresponding to a specific event on at least one of the first sub-region and the second sub-region, in response to the specific event occurring. The specific event may include reception of an alarm message about an event occurring at an apparatus connected to a home network or a state change, and the controller is further configured to control the flexible display to display the alarm message on the at least one of the first sub-region and the second sub-region.

The specific event may include an instruction to drive a smart TV function, and the controller is further configured to control the flexible display to display TV contents on the main region and a control icon for the TV contents on the at least one of the first sub-region and the second sub-region, in response to receiving the instruction to drive the smart TV function being input.

The specific event may be an instruction to play first content having a ratio different from a ratio of second content being displayed on the main region; and the controller is further configured to control the flexible display to display the first content on at least a portion of the main region and the at least one of the first sub-region and the second sub-region.

The flexible display may be configured to change between a flat mode and a bent mode according to a user manipulation.

The main region of the flexible display may be configured to be deformed from a flat state to a concavely bent state, and the display apparatus further includes a guide member configured to guide first and second ends of the flexible display to be convexly bent in a side surface direction, in response to the flexible display being concavely bent.

The guide member may include a side surface including a pre-printed image, in response to the flexible display being in the concavely bent state, the pre-printed image is covered, and in response to the flexible display being in flat state, the pre-printed image is visible.

The display apparatus may further include a touch sensor configured to be disposed on a side surface of the display apparatus and sense a user touch gesture.

The display apparatus may further include a sensor configured to sense that a user approaches the display apparatus, and wherein the controller is further configured to control the flexible display to display at least one of a power on/off icon, a volume adjusting icon, and a source changing icon on the at least one of the first sub-region and the second sub-region, in response to the sensor sensing that the user approaches the display apparatus.

The controller may be further configured to control the flexible display so that a size of the sub-region on which the UI element is displayed varies according to a screen ratio of the content displayed on the main region.

According to another aspect of an aspect of an exemplary embodiment, there is provided a display method of a display apparatus including a flexible display configured to be concavely bent and including a main region, a first sub-region adjacent to the first side surface of the main region, and a second sub-region adjacent to a second side surface of the main region, the display method including: sensing an occurrence of a specific event; and displaying a user interface (UI) element corresponding to the specific event on at least one of the first sub-region and the second sub-region.

The s specific event may include reception of an alarm message about an event occurring at an apparatus connected to a home network or a state change, and wherein the displaying comprises displaying the alarm message on the at least one of the first sub-region and the second sub-region.

The specific event may include an instruction to drive a smart TV function, and wherein the displaying comprises, in response to receiving the instruction to drive the smart TV function, displaying TV contents on the main region and a control icon for the TV contents on the at least one of the first sub-region and the second sub-region.

The specific event may be an instruction to play first content having a ratio different from a ratio of second content being displayed on the main region; and wherein the displaying comprises displaying the first content on at least a portion of the main region and the at least one of the first sub-region and the second sub-region.

The display method may further include sensing when a user approaches the display apparatus, and wherein the displaying comprises displaying at least one of a power on/off icon, a volume adjusting icon, and a source changing icon on the at least one of the first sub-region and the second sub-region, in response to the sensing.

According to another aspect of an aspect of an exemplary embodiment, there is provided an apparatus including a flexible display configured to operate in a flat mode in which the flexible display is flat and a bent mode in which the flexible display is bent; and a controller configured to control the flexible display to display content in a first ratio when the flexible display is in the flat mode and to display the content in a second ratio when the flexible display is in the bent mode.

The apparatus may further include a guide member configured to guide the flexible display during a transition between the flat mode and the bent mode.

The apparatus may further include a body; and a guideway formed between the body and the guide member though which the flexible display translates.

The apparatus may further include a driver configured to cause the flexible display to operate in the flat mode, in response to a first type of content being displayed, and to cause the flexible display to operate in the bent mode, in response to a second type of content being displayed.

The apparatus may be configured to be to network, and in response to the apparatus receiving displayable information from the network, at least one sub-region of the flexible display displays the displayable information.

The flexible display may include a main region that displays content while the at least one sub-region displays the displayable information from the network.

### BRIEF DESCRIPTION OF THE DRAWING FIGURES

The above and/or other aspects of exemplary embodiments will be more apparent by describing certain exemplary embodiments with reference to the accompanying drawings, in which:

FIG. 1 is a block diagram schematically illustrating a configuration of a display apparatus according to an exemplary embodiment of the present disclosure;

FIGS. 2A and 2B are diagrams illustrating a shape of a flexible display unit and a shape of an edge region in a case in which the display apparatus is in a flat mode;

FIGS. 3A and 3B are diagrams illustrating a shape of a flexible display unit and a shape of an edge region in a case in which the display apparatus is in a bent mode;

FIGS. 4A, 4B, and 5 are diagrams illustrating a shape of a flexible display unit according to another exemplary embodiment of the present disclosure;

FIG. 6 is a block diagram illustrating a configuration of a display apparatus according to another exemplary embodiment of the present disclosure in detail;

FIG. 7 is a diagram illustrating an example of a software configuration of a user terminal;

FIGS. 8 to 35 are diagrams illustrating various examples controlling the display apparatus using the flexible display unit including a plurality of sub-regions, according to various exemplary embodiments of the present disclosure; and

FIG. 36 is a flow chart illustrating a method for controlling a display apparatus including a flexible display unit according to various exemplary embodiments of the present disclosure.

### DETAILED DESCRIPTION OF THE EXEMPLARY EMBODIMENTS

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

The terms “first”, “second”, etc. may be used to describe diverse components, but the components are not limited by the terms. The terms are only used to distinguish one component from the others.

The terms used in the present application are only used to describe the exemplary embodiments, but are not intended to limit the scope of the disclosure. The singular expression also includes the plural meaning as long as it does not differently mean in the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

Hereinafter, the present disclosure will be described in detail with reference to the accompanying drawings.

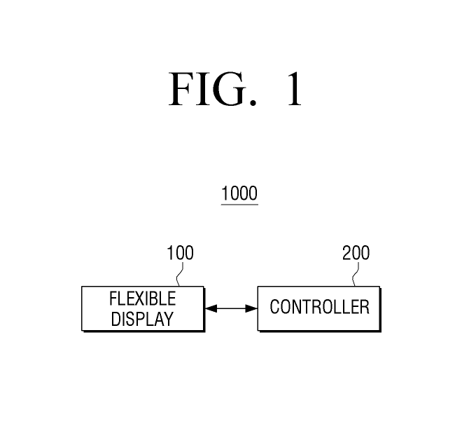

FIG. 1 is a block diagram illustrating an example of a basic configuration of a display apparatus according to various exemplary embodiments of the present disclosure. The display apparatus 1000 of FIG. 1 may be specifically implemented in various kinds of apparatuses, such as a TV, a PC, a laptop PC, a cellular phone, a tablet PC, a PDA, an MP3 player, a kiosk, an electronic picture frame, a table display apparatus, and the like. When the display apparatus 1000 is implemented in portable apparatuses, such as the cellular phone, the tablet PC, the PDA, the MP3 player, the laptop PC, and the like, the display apparatus 1000 may be designated as a mobile device, but is collectively called the display apparatus in the present specification.

Referring to FIG. 1, the display apparatus 1000 includes a flexible display 100 and a controller 200.

The flexible display 100 may change from a flat state to a bent state by bending, and from the bent state to the flat stated by flattening. Specifically, in the flat state (hereinafter “flat mode”), the flexible display 100 may display an image on a flat display region

In addition, if the display apparatus 1000 is bent (hereinafter “bent mode”) in a side surface direction (specifically, if the display apparatus 1000 is bent to be concave based on a front surface direction), the flat display region may be divided into a main region (or a main display region) disposed on the front surface of the display apparatus and a sub-region (or a sub-display region) including a portion that is bent in a side surface direction from the main region. The sub-region may have an area smaller than an area of the main region.

At least one sub-region may form a surface different from the main region. For example, the main region may be concavely deformed in the bent state. If the main region is disposed on the front surface of the display apparatus 1000, then at least one sub-region may be disposed on a different surface (e.g., a right side surface, a left side surface, or a back surface) of the display apparatus 1000. A first surface (flat or curved) including the main region and a second surface (flat or curved) including at least one sub-region may be fixed to form an obtuse angle. The forms, the positions, and the number of sub-regions may be variously implemented according to an exemplary embodiment. A detailed description thereof will be provided below together with the accompanying drawings.

The controller 200 may control the respective configurations in the display apparatus 1000. Specifically, the controller 200 may sense an operation mode of the display apparatus 1000, control the flat display region when the flexible display 100 is in the flat mode, and individually control the main region and at least one sub-region of the flexible display 100 when the flexible display 100 is in the bent mode. For example, the main region and at least one sub-region may display different content. The kind, the display method, the layout, and the like of the displayed content on the main region and at least one sub-region may be variously changed according to an exemplary embodiment. A detailed description thereof will be provided below.

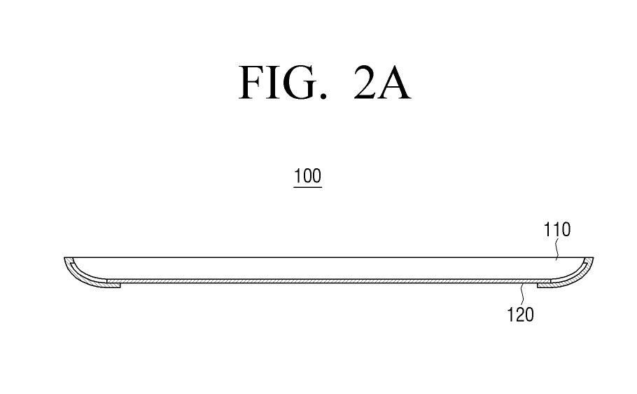

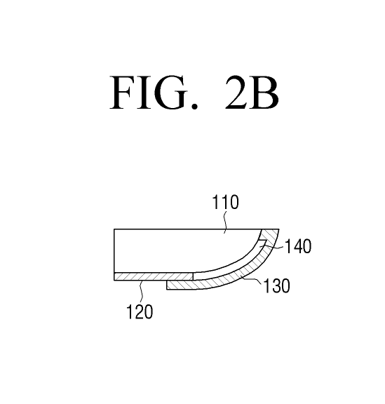

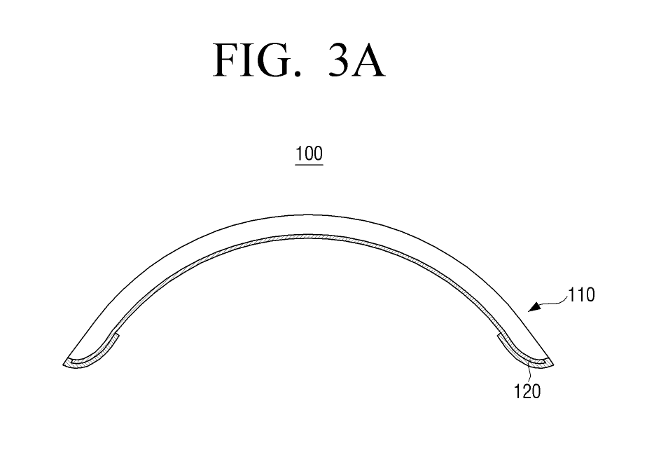

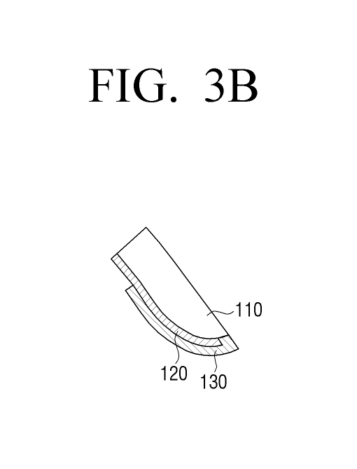

FIGS. 2A to 3B are diagrams illustrating a detailed shape of the flexible display 100 according to the present exemplary embodiment. Specifically, FIGS. 2A and 2B illustrate a shape of the flexible display in the flat mode. FIGS. 3A and 3B illustrate a shape of the flexible display in the bent mode.

Referring to FIGS. 2A to 3B, the flexible display 100 includes a body unit 110, a panel 120, and a guide member 130.

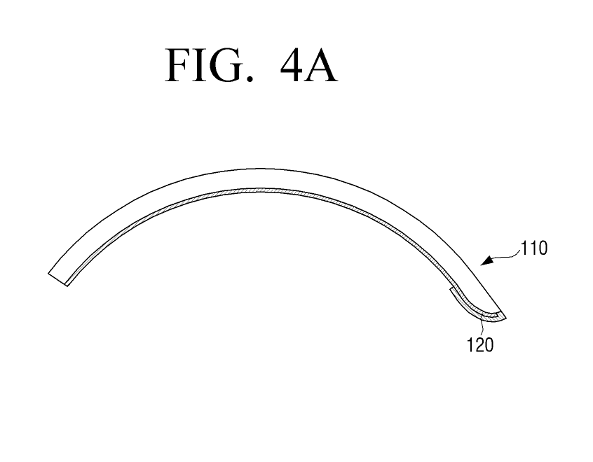

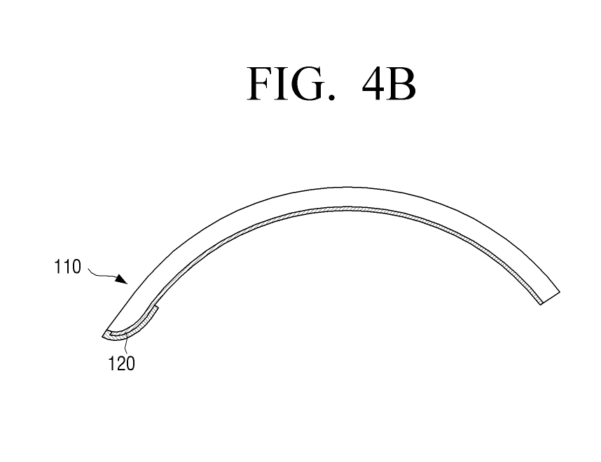

The body unit 110 is a flexible structure that may be flat or bent. The body unit 110 includes edge regions. These edge regions may be rounded as shown in FIGS. 2A to 3B, but only one edge region may be rounded as shown in FIGS. 4A and 4B. In the latter case, the other edge region of the body unit may be squared.

The guide member 130 guides a movement of the panel 120 according to a bending of the flexible display 100. Specifically, to transition from flat mode to bent mode, the guide member 130 may guide both ends of the flexible display 100 to be convexly bent in the side surface direction. The manner of this concave bending is caused by a guideway 140. The guide member 130 may be made of a transparent material. As shown in FIG. 2B, the guide member 130 includes a guideway 140 into which the that the panel 120 translates for the bent mode (See, e.g., FIG. 3B). A touch sensor may be disposed on the guide member 130. An image may be printed on the edge region of the body unit 110 below the guide member 130. Alternatively, a printed matter having a preset image may be attached to the edge region of the body unit 110 below the guide member 130.

The panel 120 is disposed on the body unit 110 and has a horizontal length shorter than the body unit 110. In addition, the panel 120 may have a form changed according to a form change of the body unit 110. Specifically, a center of the panel 120 may be fixed to a center of the body unit 110, and both side surfaces (specifically, left and right side surfaces) of the panel 120 may be horizontally moved by the guide member 130 and translate into the guideway 140 (e.g., for the bent mode) and out of the guideway (e.g., for the flat mode). The side surfaces of the panel 120 may be vertically fixed to the guide member 130. Therefore, when the body unit 110 is disposed to be flat, the panel 120 is also flat, and when the body unit 110 is bent, the panel 120 is also bent.

In the bent mode, a radius of curvature of the panel 120 is less than that of the body unit 110. Therefore, in the case in which the flexible display 100 is bent (more specifically, in the case in which the flexible display 100 is bent to be concave based on the front surface), both ends of the panel 120 and both ends of the body unit 110 are close to each other. In the bent mode, the panel 120 is disposed on the edge region(s) of the guide member 130 and therefore is disposed in the side surface and the front surface of the display apparatus 1000.

In the case in which the flexible display 100 is bent as described above, the flexible display 100 may be divided into a main region disposed on the front surface of the display apparatus 1000, a first sub-region of a right side surface of the display apparatus 1000, and a second sub-region of a left side surface of the display apparatus 1000.

A specific shape may be printed on the edge region(s) of the body unit 110. In addition, the guide member 130 may be made of the transparent material, and in a case in which the touch sensor is disposed, the corresponding edge region in a state in which the flexible display 100 is flat may operate as a region receiving power on/off instruction, sound up/down instruction, and the like of the display apparatus 1000.

The differentiation between the flat mode and the bent mode may be determined by the designer. For example, in a case that the flexible display is not bent entirely, the flexible display may be determined to be in bent mode. However, a threshold between the flat mode and the bent mode may be defined by whether the bend is greater than a preset angle (or a preset radius of curvature or less (e.g., 4000R)).

As mentioned above, the edge region may be provided on only one edge region (e.g., the right side surface as illustrated in FIG. 4A or the left side surface as illustrated in FIG. 4B). In this case, body units 110 and panel 120 may be fixed to each other on side surfaces opposite to the edge regions, not necessarily the center.

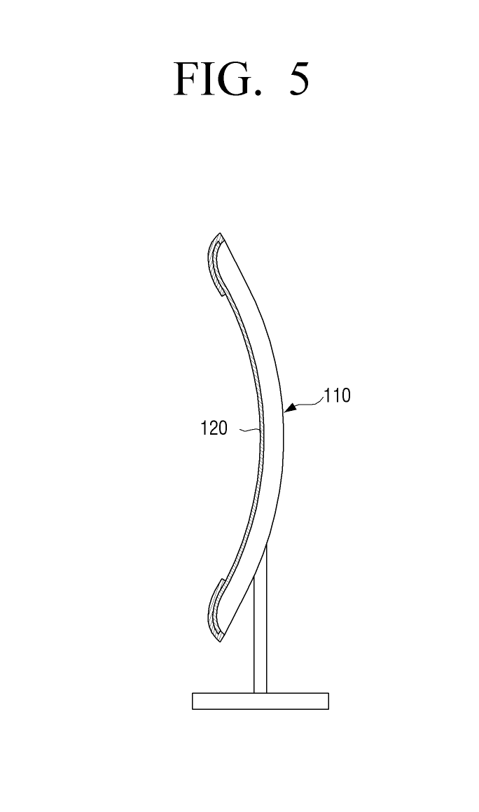

So far the flexible display 100 has been described as being bent in the in the horizontal direction. However, the flexible display 100 may also be bent in a vertical direction as illustrated in FIG. 5. In this case, the edge regions may be disposed on and below the flexible display. Moreover, the flexible display may include at least three modes: the flat mode, a left-right curved mode (e.g., FIGS. 3A to 4B), and an up-down curved mode (e.g., FIG. 5).

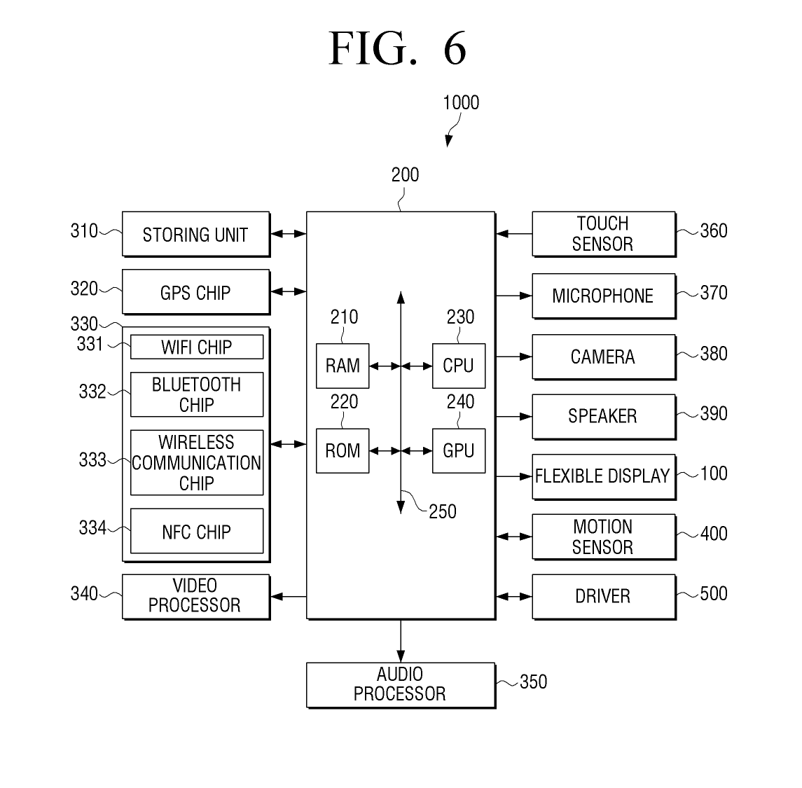

FIG. 6 is a block diagram illustrating a configuration of a display apparatus according to another exemplary embodiment of the present disclosure. For example, this embodiment describes the display apparatus 1000 as implemented in a cellular phone.

Referring to FIG. 6, the display apparatus 1000 includes the flexible display 100, the controller 200, a storing unit 310 (e.g., a memory), a global positioning system (GPS) chip 320, a communicating unit 330, a video processor 340, an audio processor 350, a touch sensor 360, a microphone 370, a camera 380, a speaker 390, a motion sensor 400, and a driver 500.

The flexible display 100 may include a flat display region in a flat state, and may be divided into the main region and at least one sub-region in a bent state. The flexible display 100 may be implemented in various forms of displays such as a liquid crystal display (LCD), organic light emitting diodes (OLED) display, a plasma display panel (PDP), and the like. The flexible display 100 may include a driving circuit, a backlight unit, and the like which may be implemented in forms such as an amorphous silicon Thin Film Transistor (a-si TFT), a low temperature poly silicon (LTPS) TFT, an organic TFT (OTFT), and the like. Meanwhile, the flexible display 100 may be coupled to the touch sensor 360 to be implemented in a flexible touch screen.

In this case, the touch sensor 360 may include one or more of a touch panel, a pen recognizing panel, and the like. The touch panel may sense a finger gesture input of a user and may output a touch event value corresponding to a sensed touch signal. The touch panel may be mounted below both the main region and the sub-region of the flexible display 100, or may be mounted only below the sub-region of the flexible display 100. Examples of schemes in which the touch panel senses the finger gesture input of the user may include a capacitive scheme and a resistive scheme. The capacitive scheme is a scheme in which micro-electricity led into a body of the user is sensed to calculate a touch coordinate. The resistive scheme is a scheme in which two electrode plates embedded in the touch panel are included and the fact that upper and lower plates of a touched point are in contact with each other to allow a current to flow is sensed to calculate the touch coordinate.

The pen recognizing panel may sense a pen gesture input of the user according to an operation of a touch pen (e.g., a stylus pen, a digitizer pen, or the like) of the user, and output a pen proximity event value or a pen touch event value. The pen recognizing panel may be mounted below at least one of the main region and a plurality of sub-regions of the flexible display 100. The pen recognizing panel may be implemented in an electro-magnetic resonance (EMR) scheme, for example, and may sense a touch or a proximity input depending on an intensity change of an electromagnetic field due to a proximity or a touch of a pen. Specifically, the pen recognizing panel may be configured to include an electromagnetic induction coil sensor (not shown) having a grid structure, and an electronic signal processing unit (not shown) that sequentially provides an alternative current signal having a predetermined frequency to the respective loop coils of the electromagnetic induction coil sensor. If a pen embedding a resonance circuit is present in the proximity of the loop coil of the pen recognizing panel described above, the magnetic field transmitted from the corresponding loop coil generates a current in the resonance circuit in the pen based on a mutual electromagnetic induction. Based on the above-mentioned current, an induction magnetic field is generated from the coil configuring the resonance circuit in the pen, and the pen recognizing panel detects the induction magnetic field from the loop coil which is in a signal receiving state, such that a proximity position or a touch position of the pen may be sensed.

The storing unit 310 may store a variety of programs and data necessary to operate the display apparatus 1000. Specifically, the storing unit 310 may store the program, the data, and the like for configuring a variety of screens to be displayed on the flat display region, the main region, and the sub-regions.

The controller 200 may display different contents on the flat display region (i.e., the main region, the first sub-region, and the second sub-region) of the flexible display 100 using the programs and the data stored in the storing unit 310, or display the contents on the main region and the sub-region, respectively. In addition, if the user touch is performed on the main region, the sub-regions, or the like, the controller 200 performs a control operation corresponding to the touch and the region of the touch.

The controller 200 includes a random access memory (RAM) 210, a read only memory (ROM) 220, a central processing unit (CPU) 230, a graphic processing unit (GPU) 240, and a bus 250. The RAM 210, the ROM 220, the CPU 230, the GPU 240, and the like may be connected to each other through the bus 250.

The CPU 230 accesses the storing unit 310 and performs a booting using an operating system (O/S) stored in the storing unit 310. In addition, the CPU 230 performs various operations using a variety of programs, contents, data, and the like stored in the storing unit 310.

The ROM 220 stores a set of instructions for booting a system, and the like. When turn-on instruction is input to supply power, the CPU 230 copies the 0/S stored in the storing unit 310 in the RAM 210 according to the instructions stored in the ROM 220 and executes the O/S so as to boot the system. When the booting is completed, the CPU 230 copies a variety of programs stored in the storing unit 310 in the RAM 210 and executes the programs copied in the RAM 210 so as to perform a variety of operations. When the booting of the display apparatus 1000 is completed, the GPU 240 displays an UI screen on an activated region among the flat display region, the main region, and the sub-regions. Specifically, the GPU 240 may generate a screen including various objects such as an icon, an image, a text, and the like using a calculating unit (not shown) and a rendering unit (not shown). The calculating unit calculates attribute values such as coordinate values, shapes, sizes, colors, and the like in which the respective objects are to be displayed according to a layout of the screen. The rendering unit generates the screen of various layouts including the objects based on the attribute values calculated by the calculating unit. The screen generated by the rendering unit may be provided to the flexible display 100, so as to be displayed on the flat display region, or to be individually displayed on the main region and the sub-regions, respectively.

The GPS chip 320 is a component receiving a GPS signal from a GPS satellite to calculate a current position of the display apparatus 1000. When the controller 200 uses a navigation program or necessary to a current position of the user in addition to that, the controller 200 may calculate the position of the user using the GPS chip 320.

The communicating unit 330 is a component performing communications with various types of external devices according to various types of communication schemes. The communicating unit 330 includes a WiFi chip 331, a Bluetooth chip 332, a wireless communication chip 333, and a near field communications (NFC) chip 334. The controller 200 performs communications with a variety of external devices using the communicating unit 330. Specifically, the communicating unit 330 may receive control instruction from a control terminal (e.g., a remote controller) which may control the display apparatus 1000. Alternatively, the communicating unit 330 may directly receive an alarm message from the respective home appliances in a home network, and may also transmit a control instruction for controlling the corresponding apparatus to the respective home appliances. Meanwhile, the communicating unit 330 may directly communicate the control instructions for the alarm message and the home appliances described above to the corresponding appliance as well as may also perform communication via a router or a home server connected to the home appliances.

The WiFi chip 331 and the Bluetooth chip 332 perform the communication in a WiFi scheme and a Bluetooth scheme, respectively. In a case in which the WiFi chip 331 or the Bluetooth chip 332 is used, a variety of access information such as SSID, a session key, and the like may be first transmitted and received, a communication access may be performed using the variety of access information, and a variety of information may be then transmitted and received. The wireless communication chip 333 means a chip performing communications according to various communication standards such as IEEE, ZigBee, 3rd generation (3G), 3rd generation partnership project (3GPP), Long Term Evolution (LTE), and the like. The NFC chip 334 means a chip which is operated in the NFC scheme using a frequency band of 13.56 MHz of various RF-ID frequency bands such as 135 kHz, 13.56 MHz, 433 MHz, 860 to 960 MHz, 2.45 GHz, and the like.

The video processor 340 is a component for processing the contents received through the communicating unit 330, or video data included in the contents stored in the storing unit 310. The video processor 340 may perform various image processes such as decoding, scaling, noise filtration, frame rate conversion, resolution conversion, etc. for the video data.

The audio processor 350 is a component for processing the contents received through the communicating unit 330, or audio data included in the contents stored in the storing unit 310. The audio processor 350 may perform various processes such as decoding, amplification, noise filtration, etc. for the audio data.

When a playback program for multimedia contents is executed, the controller 200 may drive the video processor 340 and the audio processor 350 to play the corresponding contents.

In the case in which the display apparatus 1000 is in the flat mode, the controller 200 may control the flexible display 100 so that an image frame generated by the video processor 340 is displayed on the flat display region (i.e., the main region, the first sub-region, and the second sub-region). Meanwhile, in the case in which the display apparatus 1000 is in the bent mode, the controller 200 may control the flexible display 100 so that the image frame generated by the video processor 340 is displayed on at least one region of the main region and the sub-regions.

In addition, the speaker 390 outputs the audio data generated by the audio processor 350.

The touch sensor 360 may include a touch sensor sensing the touch gesture of the user. The above-mentioned touch sensor 360 may also be disposed only on the side surface of the display apparatus 1000. For example, the touch sensor 360 may be disposed only on some regions of the guide member 130 illustrated in FIGS. 3 and 5.

Hereinabove, although the case in which the control instruction of the user is received only by the touch gesture has been described, the display apparatus 1000 may further include a button on an exterior of the body, and may receive various user manipulation instructions through the button.

The microphone 370 is a configuration for receiving and converting the user voice or other sounds into the audio data. The controller 200 may use the user voice received through the microphone 370 during a call process, or convert the user voice into the audio data, so as to be stored in storing unit 310.

The camera 380 is a configured to photograph a still image or a moving image according to a control of the user. The camera 380 may be implemented by a plurality of cameras such as a front camera and a rear camera. As described above, the camera 380 may be used as a means for obtaining an image of the user in an example for tracking a gaze of the user.

In a case in which the camera 380 and the microphone 370 are provided, the controller 200 may also perform a control operation according to the user voice input through the microphone 370 or a user motion recognized by the camera 380. That is, the display apparatus 1000 may be operated in a motion control mode or a voice control mode. In the case in which the display apparatus 1000 is operated in the motion control mode, the controller 200 activates the camera 380 to photograph the user, and tracks a change in the motion of the user to perform a control operation corresponding to the change in the motion. In the case in which the display apparatus 1000 is operated in the voice control mode, the controller 200 may analyze the user voice input through the microphone 370, and may also be operated in a voice recognizing mode performing a control operation according to the analyzed user voice.

In the display apparatus 1000 supporting the motion control mode or the voice control mode, a voice recognizing technology or a motion recognizing technology may be used in various exemplary embodiments described above. For example, if the user takes a motion selecting an object displayed on a home screen, or speaks voice instruction corresponding to the object, it may be determined that the corresponding object is selected and a control operation matched to the object may be performed.

The motion sensor 400 is a component for sensing a motion of the user. Specifically, the motion sensor 400 may include an ultrasonic wave sensor, and may sense the motion of the user or a distance using the ultrasonic wave sensor. In addition, the motion sensor 400 may also sense the motion of the user or the distance based on the image photographed by the camera 380 described above.

The driver 500 varies the state of the flexible display 100. Specifically, the driver 500 may include a movement member, a motor, a manual movement mechanism such as a lever, and the like. The driver 500 changes the state of the flat flexible display 100 to be bent or the bent flexible display 100 to be flat.

In addition to this, although not illustrated in FIG. 6, according to some exemplary embodiments, the display apparatus 1000 may further include an USB port to which an USB connector may be connected, various external input ports for connection with various external terminals such as a headset, a mouse, a LAN, and the like, a digital multimedia broadcasting (DMB) chip for receiving and processing a DMB signal, various sensor, and the like.

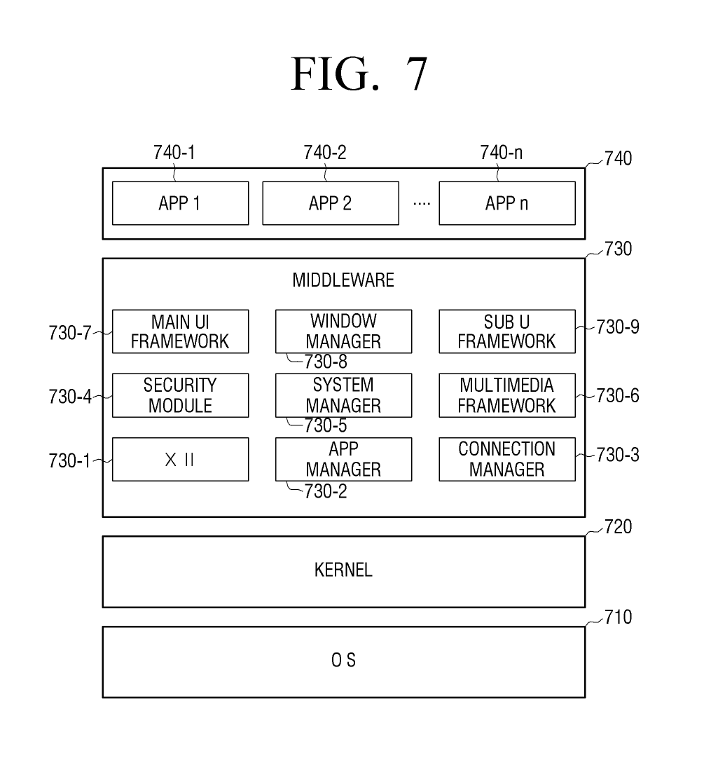

The storing unit 310 may store various programs. FIG. 7 is a diagram illustrating a structure of software stored in the display apparatus 1000. Referring to FIG. 7, the storing unit 310 may store software including an operating system (OS) 710, a kernel 720, middleware 730, an application 740, and the like.

The OS 710 performs a function that controls and manages a general operation of hardware. That is, the OS 710 is a layer performing a basic function such as a hardware management, a memory, a security, or the like.

The kernel 720 serves as a passage transmitting a variety of signals including the touch signal, or the like sensed by the flexible display 100 to middleware 730.

Middleware 730 includes a variety of software modules controlling an operation of the display apparatus 1000. The middleware 730 includes an X11 module 730-1, an APP manager 730-2, a connection manager 730-3, a security module 730-4, a system manager 730-5, a multimedia framework 730-6, a main UI framework 730-7, a window manager 730-8, and a sub-UI framework 730-9.

The X11 module 730-1 is a module receiving a variety of event signals from a variety of hardware included in the display apparatus 1000. Here, the event may be variously set such as an event in which the user gesture is sensed, an event in which a system alarm is generated, an event in which a communication from a remote control or mobile device is received, an event in which a specific program is executed or terminated, and the like.

The APP manager 730-2 is a module managing an execution state of a variety of applications 740 installed in the storing unit 310. If the APP manager 730-2 senses an application execution event from the X11 module 730-1, the APP manager 730-2 calls and executes an application corresponding to the corresponding event.

The connection manager 730-3 is a module for supporting a wired or wireless network connection. The connection module 730-3 may include various detail modules such as a DNET module, an UPnP module, and the like.

The security module 730-4 is a module for supporting certification, request permission, secure storage, and the like for hardware.

The system manager 730-5 monitors states of the respective components in the display apparatus 1000 and provides the monitored result to other modules. For example, if a case in which battery remainder is lack or error occurs, a case in which a communication connection is disconnected, and the like occur, the system manager 730-5 may provide the monitored result to the main UI framework 730-7 or the sub-UI framework 730-9 to output an alarm message or an alarm sound.

The multimedia framework 730-6 is a module for performing a playback of multimedia contents stored in the display apparatus 1000 or provided from an external source. The multimedia framework 730-6 may include a player module, a camcorder module, a sound processing module, and the like. Therefore, the multimedia framework 730-6 may play a variety of multimedia contents to perform an operation generating and playing the screen and the sound.

The main UI framework 730-7 is a module for providing a variety of UIs to be displayed on the main region of the flexible display 100, and the sub-UI framework 730-9 is a module for providing a variety of UIs to be displayed on the sub-regions. The main UI framework 730-7 and the sub-UI framework 730-9 may include an image compositor module configuring a variety of objects, a coordinate compositor module calculating a coordinate at which the object is to be displayed, a rendering module rendering the configured object to the calculated coordinate, a 2D/3D UI toolkit providing a tool for configuring a 2D or 3D type of UI, and the like.

The window manager 730-8 may sense a touch event using a body of the user or the pen, or other input events. If the window manager 730-8 senses the above-mentioned event, the window manager 730-8 transmits the event signal to the main UI framework 730-7 or the sub-UI framework 730-9 to perform an operation corresponding to the event.

In addition to this, the window manager 730-8 may also store various program modules such as a writing module for drawing a line along a drag trajectory when the user touches and drags the screen, a position calculation module calculating a user position based on an ultrasonic wave sensor value sensed by the sensor 400, a gaze calculating module for calculating a gaze direction of the user from the user image photographed by the camera 380, and the like.

The application module 740 includes applications 740-1 to 740-n for supporting various functions. For example, the application module 740 may include a program module for providing various services such as a navigation program module, a game module, an electronic book module, a calendar module, an alarm management module, and the like. The above-mentioned applications may also be installed to default, and may also be arbitrarily installed and used by the user during a use process. If the object is selected, the CPU 230 may execute an application corresponding to the selected object using the application module 740.

The structure of software illustrated in FIG. 7 is merely an example, and is not necessarily limited thereto. Therefore, in some cases, some of the structure may be omitted or modified, in addition other structure may be added. For example, the storing unit 310 may also additionally include various programs such as a sensing module for analyzing signals sensed by a variety of sensors, a messaging module such as a messenger program, a short message service (SMS) & multimedia message service (MMS) program, an e-mail program, or the like, a call info aggregator program module, a VoIP module, a web browser module, and the like.

Meanwhile, as described above, the display apparatus 1000 may be implemented in various kinds of apparatuses such as a cellular phone, a tablet PC, a laptop PC, a PDA, an MP3 player, an electronic picture frame, a TV, a PC, a kiosk, and the like. Therefore, the configuration described in FIGS. 6 and 7 may be variously modified according to a kind of display apparatus 1000.

As described above, the display apparatus 1000 may be implemented in various forms and configurations. The controller 200 of the display apparatus 1000 may support various user interactions according to exemplary embodiments.

Hereinafter, a user interaction method according to various exemplary embodiments of the present disclosure will be described in detail.

According to an exemplary embodiment of the present disclosure, the controller 200 senses an operation state of the flexible display 100. Specifically, the controller 200 may sense a bent state of the flexible display 100 using a sensor sensing whether the panel is positioned on the edge region of the body unit 110, or a sensor capable of sensing arrangement forms of a center and both ends of the panel, or may sense the bent state of the flexible display 100 by checking the operation state of the driver 500 capable of changing the bent state of the flexible display 100.

In addition, if the flexible display 100 is in the flat state, the controller 200 may display the contents on the flat display region. In addition, if a specific event occurs in this state, the controller 200 may display the UI element corresponding to the specific event on a preset region (e.g., a lower end portion) of the flat display region.

In a case in which a screen ratio of the flexible display 100 is 21:9, or a screen ratio of the contents displayed on the flat display region is 16:9, blank regions in which the image is not displayed are present at left and right of the flat display region. In this case, if the specific event occurs, the controller 200 may display an UI element corresponding to the specific event on the blank region.

If the flexible display 100 is in the bent state, the controller 200 may display contents, which are pre-selected by the user, on the main region, and may display an UI element corresponding to the event on the sub-regions.

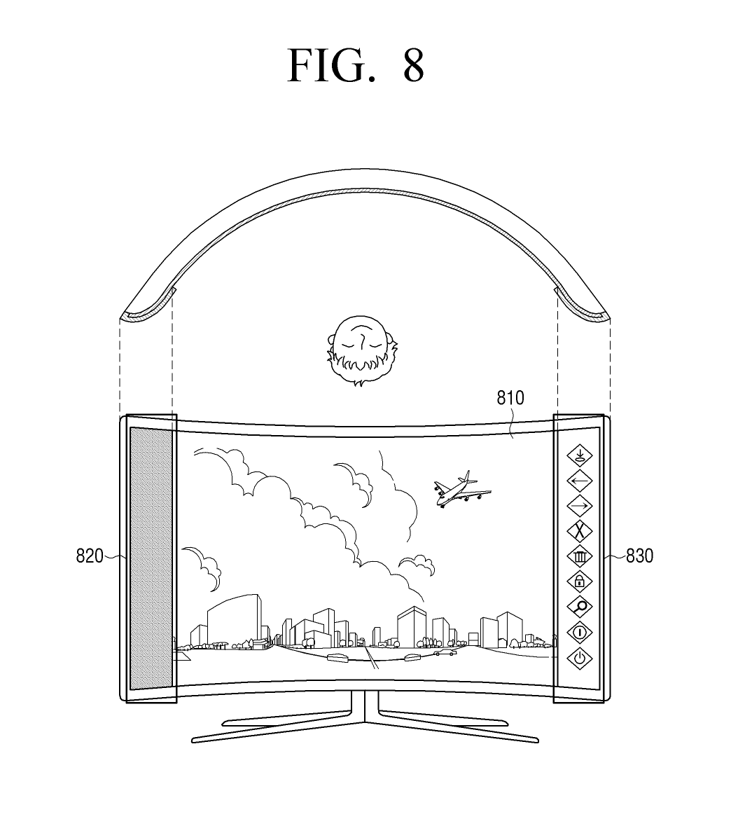

For example, if the flexible display 100 is bent and a portion of a left region of the panel and a portion of a right region of the panel are each disposed in the guide member as illustrated in FIG. 8, the flat display region may be divided into a main region 810, which is disposed on the front surface of the display apparatus 1000, and a first sub-region 820 and a second sub-region 830 including portions which are bent in side surface directions of the display apparatus from the main region. As such, if the portion of the flexible display 100 is disposed in the side surface direction of the display apparatus 1000 as the portion of the flexible display 1000 is bent, the UI element corresponding to the event may be displayed on the sub-regions 820 and 830.

The case in which the UI element is displayed only on the sub-region 830 has been described in FIG. 8. However, the UI element may also be displayed on only the left sub-region 820, and may also be displayed on both sub-regions 820 and 830. In addition, the displayed UI element may be variously changed according to a kind of contents currently displayed on the main region 810 and/or a kind of event.

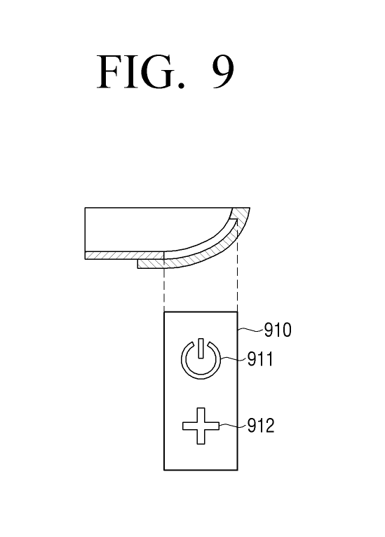

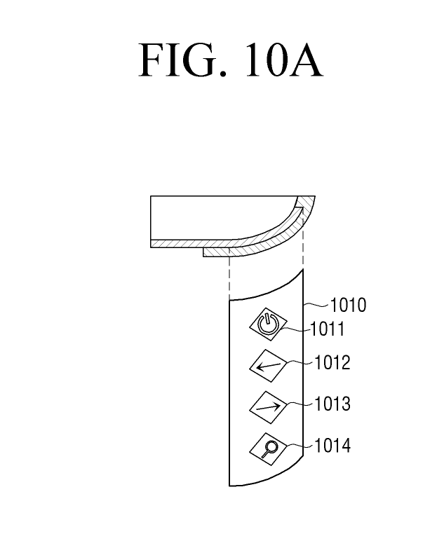

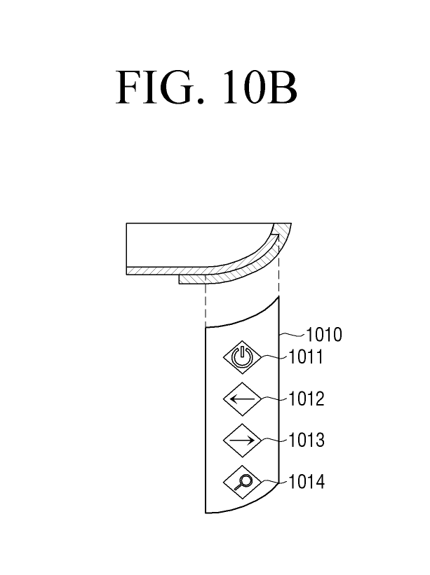

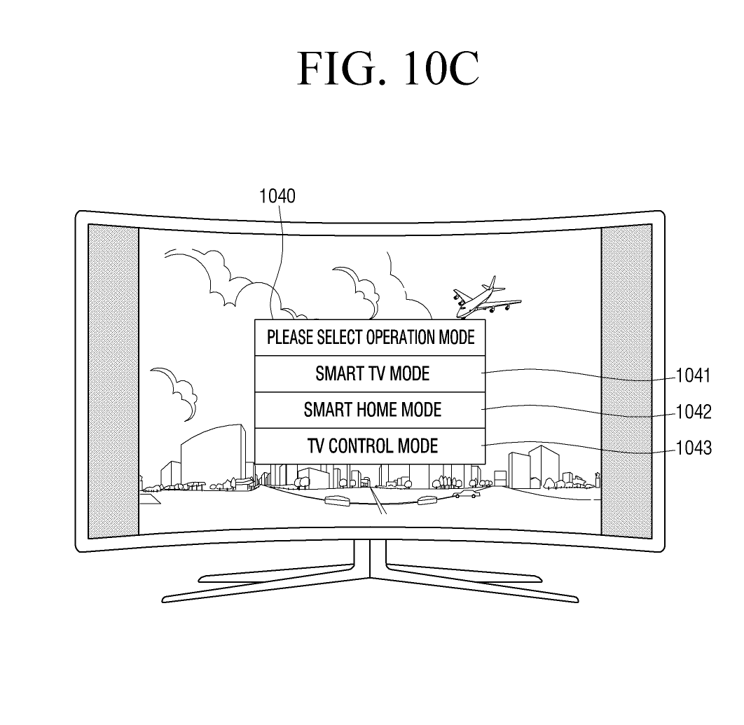

FIGS. 9, 10A and 10B are diagrams illustrating examples of icons displayed on the edge region of the display apparatus. FIG. 9 shows an example of icons displayed on the edge region in the flat mode, and FIGS. 10A and 10B show examples of icons displayed on the edge region in the bent mode. The following description assumes that preset icons are printed on the edge region of the body unit 110, that the guide member 130 is a transparent bezel, and that the touch sensor 360 capable of sensing the touch gesture is disposed.

Referring to FIG. 9, the panel 120 is not positioned on the edge region of the body unit 110, so the screen printed on the edge region is displayed to the user as it is. However, since the edge region is disposed at the side surface of the display apparatus, a user positioned at the side surface in the state in which the flexible display 100 is flat has a good view of the edge region, but a user positioned at the front surface does not have a good view of the edge region.

Although the printed screen illustrates only an icon 911 for receiving instruction for controlling a turn on/off of a power supply of the display apparatus 1000 and an icon 912 for controlling a volume, other icons may be further displayed.

If the user touches a transparent bezel region on the icon 911, the controller 200 may determine that the user inputs control off (or power on) instruction and may perform an operation accordingly.

Meanwhile, if the flexible display 100 is in the bent state, the panel 120 is positioned at the edge region of the body unit 110, such that an icon 910 printed on the edge region is covered with the panel 120.

Therefore, in response to the preset event, as shown in FIGS. 10A and 10B a plurality of UI elements 1011, 1012, 1013, and 1014 may be displayed on a sub-region 1010 of the flexible display 100 positioned on the edge region.

Since the flexible display 100 is in the bent state and a portion of the sub-region 1010 which is in contact with the main screen is bent while having an R value, an image of a portion in which the main region and sub-region are in contact with each other may be viewed to be distorted to the user positioned at the front surface of the display apparatus 1000. Specifically, as illustrated in FIG. 10B, in a case in which the same image as that in the state displayed in the flat state is displayed, the corresponding image may be viewed to be distorted to the user at the front surface.

Therefore, the display apparatus 1000 may perform an image correction for the sub-region 1010 positioned on the edge region, that is, an image of the sub-region 1010 in the state in which the flexible display 100 is in the bent state, to be viewed as an image displayed on the flat surface. For example, as illustrated in FIG. 10B, the image of the portion which is in contact with the main screen may be assigned with deepness using a curvature R of the edge region, so as to be processed to be viewed to protrude forward. Specifically, the sub-region 1010 is divided into a plurality of regions by taking account of the curvature R and different image processing scheme is applied to each region, such that the image may be corrected. In this case, the image corresponding to each region may be corrected by assuming a virtual flat surface and using a depth difference value between a shape of an actual edge region and the virtual flat surface. The edge region may be divided into a plurality of regions having different curvatures R, and in this case, the image may be corrected by further segmenting the sub-region 1010 and applying different image processing schemes to each region. The above-mentioned processing allows the user of the front surface of the display apparatus not to feel a boundary sense between the image of the sub-region and the main region.

Only the image processing scheme for the sub-region is not applied, but in the case in which the flexible display 100 is bent, a 3D effect is given to an overall region to perform a processing of the overall region to be viewed to protrude forward and the portion in which the main region and the sub-region are in contact with each other is processed to have different deepness, making it possible to allow the user not to feel the boundary sense between the sub-region and the main region. Even in this case, the edge region may be divided into the plurality of regions having different curvatures R so that the image may be corrected by further segmenting the sub-region 1010 and applying different image processing schemes to each region.

In response to the user selecting any one of specific UI elements 1011, 1012, 1013, and 1014 on the sub-region 1010, the controller 200 may perform a function corresponding to the UI element selected by the user.

The UI element displayed on the sub-region may be variously changed according to a kind of contents currently displayed on the main region 810 and/or a kind of occurred events.

Although the case in which the preset image is printed on the edge region has been described in the illustrated example, printed matter (e.g., a sticker or the like) may also be disposed and a separate panel may be separated from the above-mentioned flexible display 100 to be disposed only on the edge region.

FIG. 10C is an example of a user interface window for selecting an operation mode of the display apparatus. The user interface window includes a selection region 1040 including a smart TV mode 1041, a smart home mode 1042, and a TV control mode 1043.

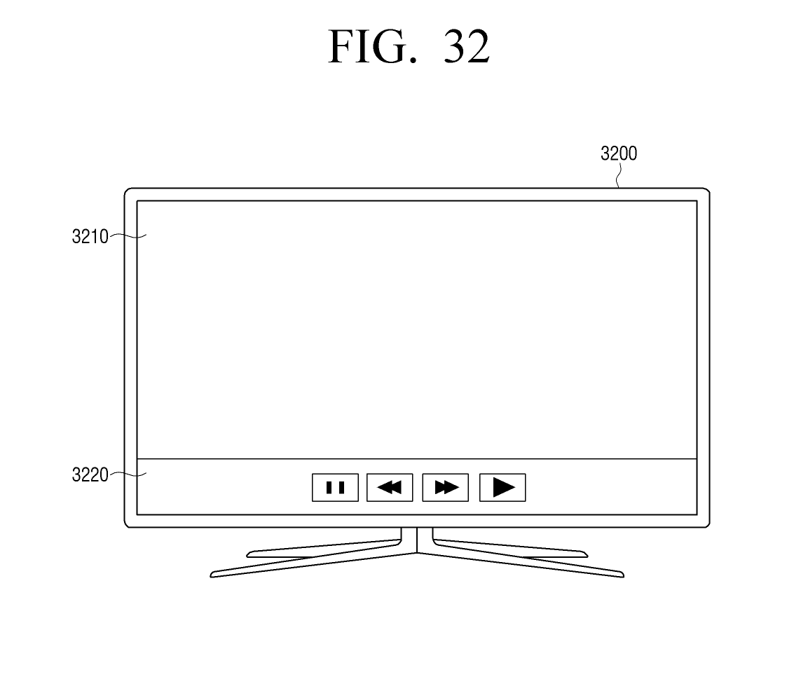

The selection region may be displayed when the user pushes a menu button (or a setting button) on a remote controller, the user selects the edge region (touches the edge region or points out the edge region with a pointer), a sensor senses a predetermined user gesture, and the like. Although only three operation modes have been illustrated in the illustrated example, other operations modes may be used. For example, a music play mode as illustrated in FIG. 32 or another mode may also be used.

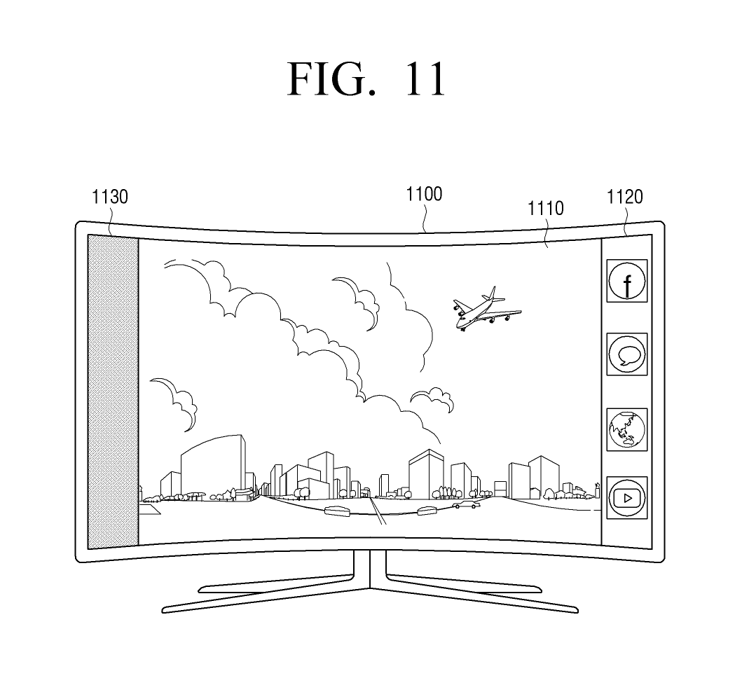

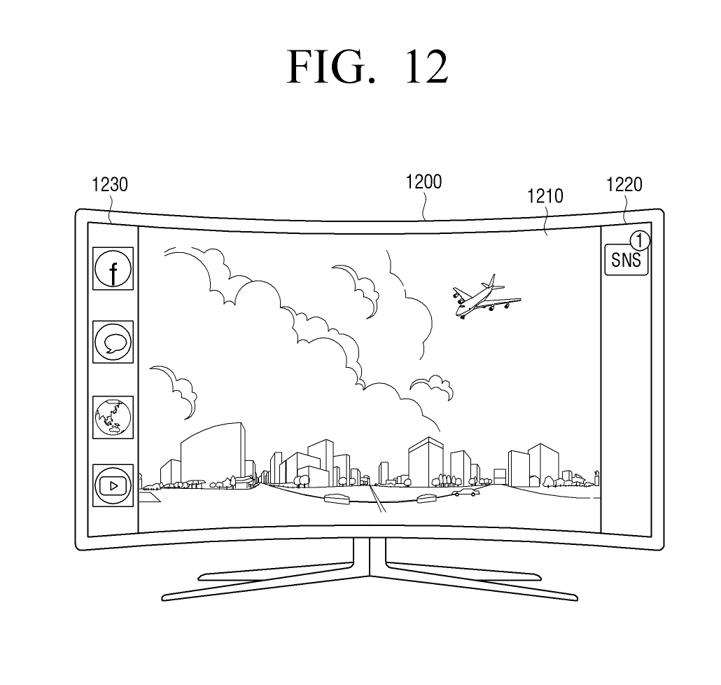

The smart TV mode 1041 is a region receiving a user selection providing information of various applications which may be installed in the display apparatus 1000 to the sub-region. When the user selects the smart TV mode 1041, a screen as illustrated in FIG. 11 or 12 may be displayed.

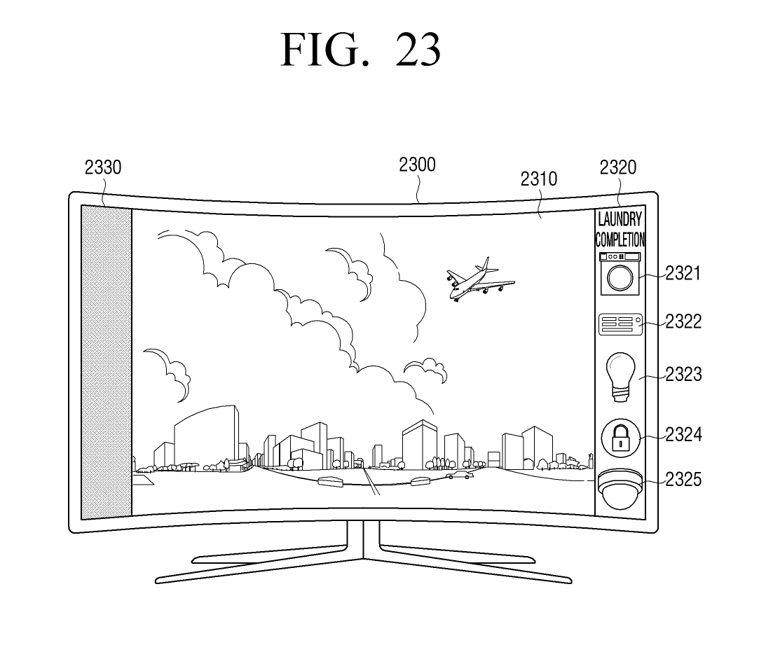

The smart home mode 1042 is a region controlling other terminals which are directly connected to the display apparatus or electronic appliances in a home network, or receiving a user selection providing information for checking states in the corresponding apparatuses to the sub-region. When the user selects the smart home mode 1042, a screen as illustrated in FIG. 23 may be displayed.

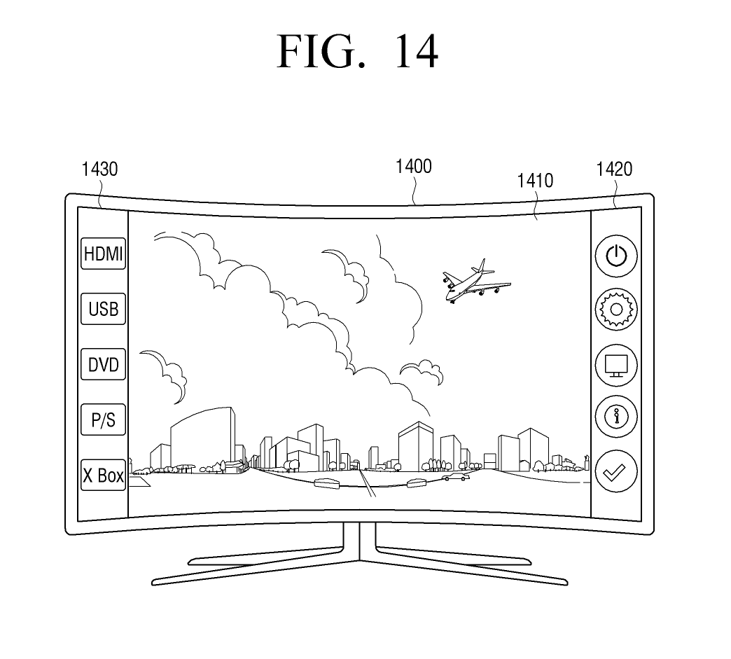

The TV control mode 1043 is a region receiving a user selection allowing an icon for receiving basic control instruction of a general display apparatus to be displayed on the sub-region. For example, upon the TV control mode, the sub-region may display icons for receiving instructions such as a change of a power state, a volume up/down, a channel up/down, and the like of the display apparatus. That is, when the user selects the TV control mode 1043, a screen as illustrated in FIG. 14 may be displayed.

Although the case in which the operation mode is determined and the UI element is then displayed on the sub-region has been described, a process of selecting a separate operation mode may be omitted. For example, if an event occurs in a pre-installed application, the display apparatus 1000 may automatically determine the smart TV mode and the UI element corresponding to the smart TV mode may be displayed on the sub-region. In addition, if an event message of which a state is changed is received from an apparatus in the home network, the display apparatus 1000 may automatically determine the smart home mode and may display the UI element corresponding to the smart home mode on the sub-region.

In addition, a direct change from the TV control mode to the smart TV mode or the smart home mode may be performed without the user interface window display as illustrated in FIG. 10C in response to mode change instruction of the user. In addition, even in a state of the smart control TV mode, the change from the smart control TV mode to the TV control mode or the smart home mode may be performed in response to the mode change instruction of the user. As described above, the mode change instruction may be a button on the remote controller, a specific action gesture, a touch gesture, voice control instruction, or the like.

FIGS. 11 and 12 are examples of the user interface window which may be displayed in a case in which the user selects a smart TV function (or the smart TV mode). Specifically, a user interface window 1100 may be displayed in a case in which the user selects the smart TV mode 1041 of FIG. 10C, or in a case in which an alarm is required from an application or operation OS stage during an operation as the smart TV function. Meanwhile, if the user inputs a back instruction during the display of the screen, the display apparatus 1000 may display the screen as illustrated in FIG. 10C.

Referring to FIG. 11, the user interface window 1100 includes a main region 1110 displaying the contents and a plurality of sub-regions 1120 and 1130.

The main region 1110 is a region displaying the contents (e.g., VOD, pre-stored image contents, cable, etc.) which are pre-selected by the user.

A first sub-region 1120 may display an SNS icon, an icon of APP related to the smart TV, an icon of APP related to the contents which are currently being viewed, and the like.

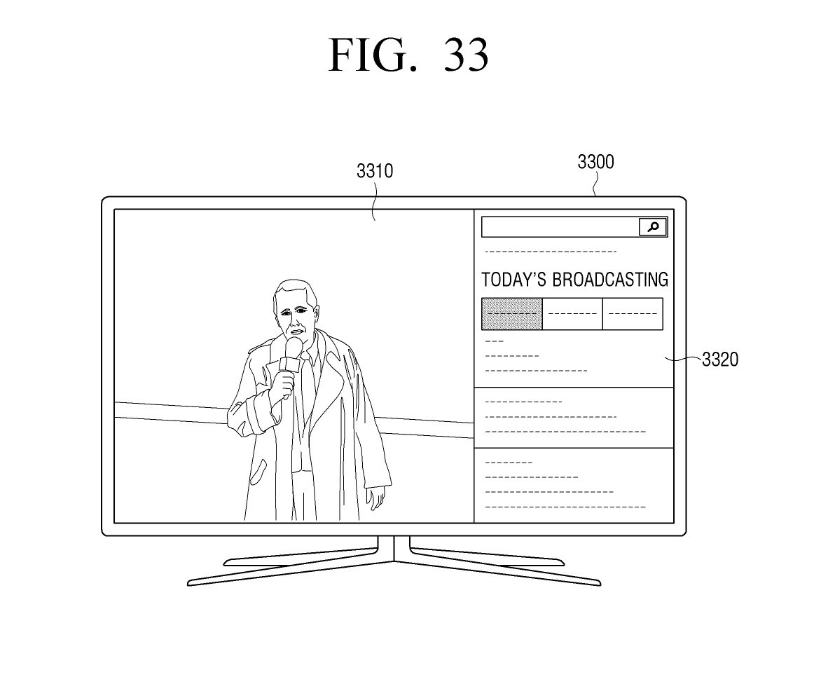

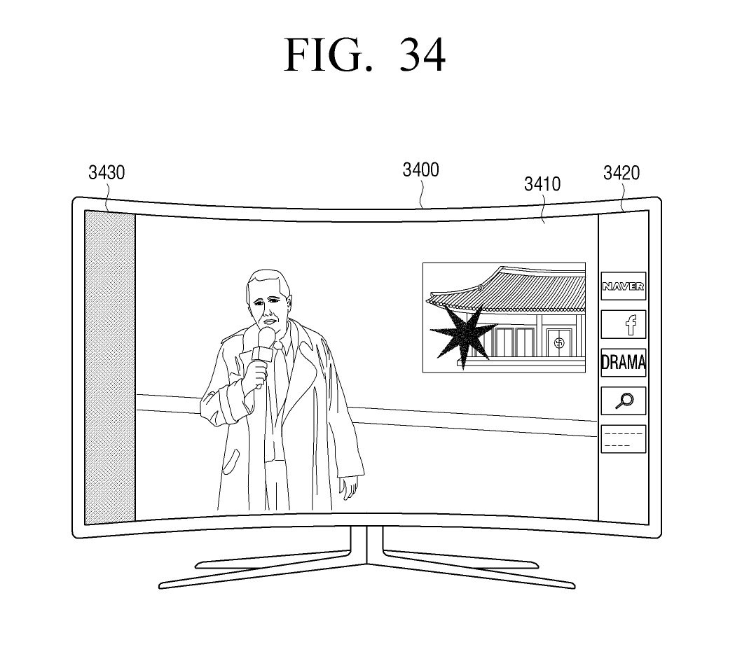

If the user selects the icon displayed on the first sub-region 1120, an application corresponding to the corresponding selected icon may be driven and the contents corresponding to the corresponding application may be displayed on the main region 1110. Alternatively, the corresponding contents may be displayed in on the first sub-region 1120, the second sub-region 1130, both the first sub-region 1120 and the second sub-region 1130, or the first and second sub-regions as well as the main region 1110. For example, if the user selects a browsing icon on the first sub-region 1120, an Internet surfing application corresponding to the browsing icon may be driven and an Internet window of the corresponding application may be displayed on the main region 1110. Alternatively, since the main region is partitioned as illustrated in FIG. 33, the contents corresponding to a new application may also be simultaneously displayed while existing contents are displayed. Alternatively, a driven result of the corresponding application may be applied to only the sub-region and may be displayed while a display operation of the main screen is maintained as illustrated in FIG. 34, this feature may be useful for stock tickers, sports scores, breaking news, calendar notifications, text messages, alerts, and the like.

The second sub-region 1130 may not display a separate image. However, the second sub-region 1130 may also simultaneously display the main contents displayed on the main region 1110. In this case, as described above, an image processing for preventing an occurrence of distortion between an image on the second sub-region 1130 and an image on the main region 1110 may be performed.

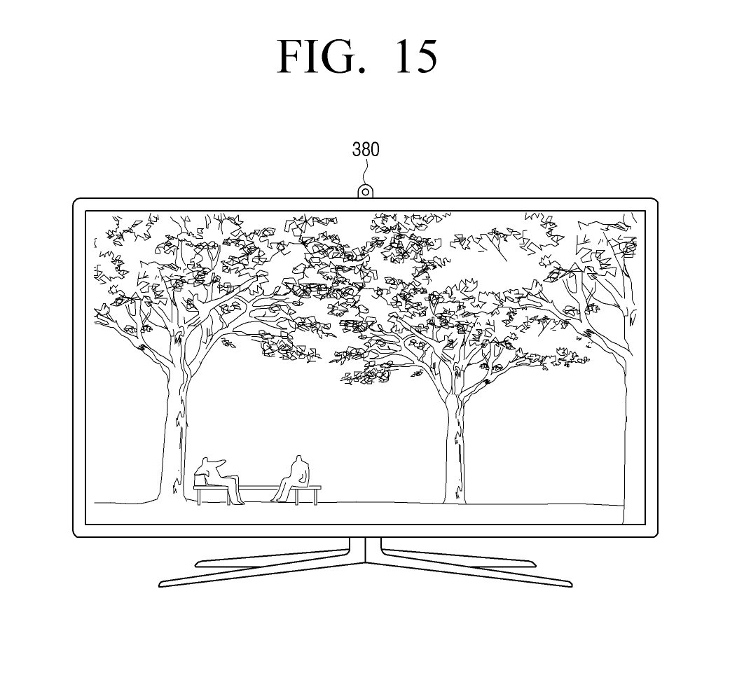

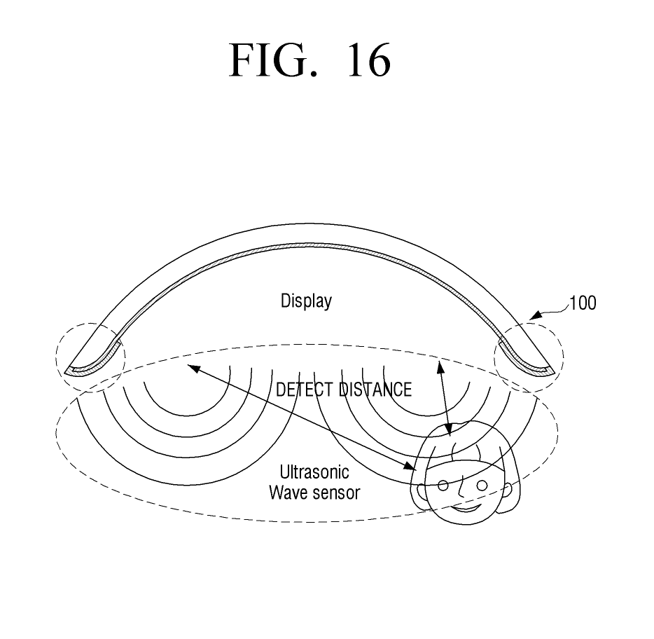

Although the case in which the UI element is displayed only on the right side of the main region 1110 has been described, the UI element may also displayed on only a sub-region 1230 of the left side of a main region 1210. Alternatively, the UI element may be displayed on both sub-regions 1220 and 1230 as illustrated in FIG. 12. In addition, the display position described above may be selected by the user in advance and may be automatically varied according to a position direction of the user. A description of this example will be provided below with reference to FIGS. 15 and 16.

Referring to FIG. 12, the user interface window 1200 includes the main region 1210 displaying the contents, a first sub-region, 1220, and the second sub-region 1230.

The main region 1210 is a region displaying the contents (e.g., the driven result of the pre-selected application (e.g., YouTube moving image), etc.) which are pre-selected by the user.

The second sub-region 1230 is a region displaying UI elements (e.g., icons corresponding to an SNS application, a web browsing application, and the like) corresponding to a lower menu of a smart TV menu.

The first sub-region 1220 is a region displaying an application in which a state change occurs, that is, an event occurs, among the pre-installed applications. In the illustrated example, a new message is received at an SNS application and this is informed. In this respect, the first sub-region 1120 and the second sub-region 1130 may be automatically displayed according to an event occurrence of the pre-installed application as well as a manipulation of the user.

As such, in the display apparatus 1000 according to the present exemplary embodiment, since information on the event occurred from the pre-installed application, and the like is displayed on the sub-region which is the edge region, not on the main region 1210, the contents which are being currently viewed are not covered during the display process described above.

Although the case in which the main contents are displayed only on the main region 1110 has been illustrated and described, the corresponding contents may be commonly displayed on the two sub-regions as well as the main region upon being implemented, and a form where a menu or information is overlaid and displayed in the sub-regions may also be implemented.

The UI content is described being displayed in the sub-regions, but the UI content or the data therefrom may be partially displayed on the main region and fully displayed on at least one sub-region, fully displayed on the main region and partially displayed on the sub-regions. For example, the relevant information may partially spill over into an adjacent region.

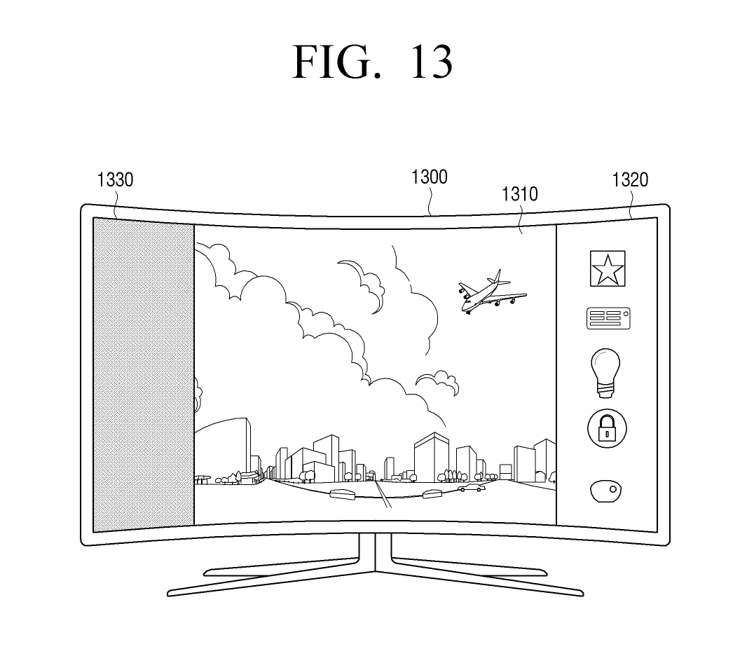

FIG. 13 is an example of the user interface window in a case in which the contents having a ratio different from a ratio of the panel are displayed. Specifically, a user interface window 1300 may be displayed in a case in which the user selects the smart home mode 1042 of FIG. 10C, or in a case in which the apparatus in the home network transmits an alarm message (e.g., in a case in which a new apparatus is connected to the home network, a state in an existing apparatus is changed, and the like). In response to the user inputting a back instruction during the display of the user interface window 1300 as described above, the display apparatus 1000 may be changed to the screen as illustrated in FIG. 10C.

Referring to FIG. 13, the user interface window 1300 includes a main region 1310 displaying TV contents and a plurality of sub-regions 1320 and 1330.

The main region 1310 is a region displaying contents which are pre-selected by the user. However, the contents displayed herein may have a ratio (e.g., 16:9) different from an aspect ratio (e.g., 21:9) of the panel.

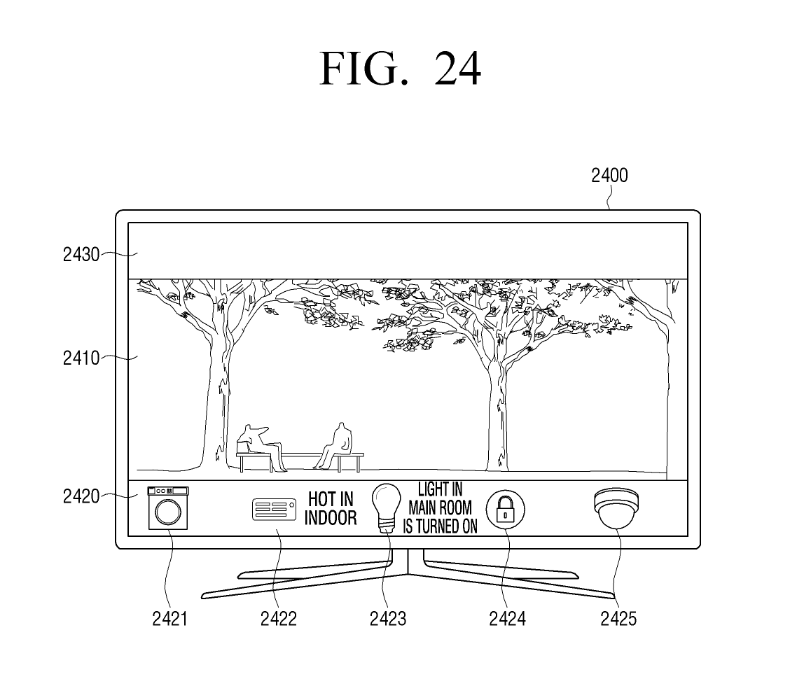

A first sub-region 1320 displays an UI element corresponding to the smart home mode. The UI element displayed in the case of smart home mode will be described below with reference to FIGS. 23 and 24.

In the case in which the ratio of the contents is different from the ratio of the panel as illustrated, a lot of regions displaying the contents on the main region 1310 may not be required. As a result, the first sub-region 1320 may be expanded to a wider region as compared to FIG. 12. Meanwhile, although the case in which the icons are displayed in a line has been described in the illustrated example, the icons may also be displayed in two columns in this case.

The second sub-region 1330 may not display a separate image.

Meanwhile, in a state in which the screen (i.e., the contents having a ratio of 16:9) as illustrated in FIG. 13 is displayed, in a case in which user instruction (i.e., play instruction of the contents having the ratio different from that of the contents which are currently being displayed on the main region) changing the contents to the same contents as the aspect ratio of the panel is input, new contents may be simultaneously displayed on the overall region (i.e., the main region, the first sub-region, and the second sub-region) of the flexible display.

FIG. 14 is an example of a user interface window which may be displayed in a case in which the user selects a main screen control mode. A user interface window 1400 may be displayed in a case in which the user selects the TV control mode 1043 of FIG. 10C, in a case in which a TV remote controller is manipulated, in a case in which an application corresponding to the TV manipulation is driven in a user terminal, or in a case in which the user approaches the display apparatus 1000. If back instruction is received from the user during the display of the user interface window 1400 as described above, the display apparatus 1000 may be changed to the screen as illustrated in FIG. 10C.

Referring to FIG. 14, the user interface window 1400 includes a main region 1410 displaying the contents and a plurality of sub-regions 1420 and 1430.

The main region 1410 is a region displaying contents which are pre-selected by the user.

A first sub-region 1420 may display an UI element for setting a power on/off, a channel up/down, or the like. Meanwhile, the first sub-region 1420 may also further include an UI element for setting a TV viewing mode, a sound mode, a viewing reservation, a recording reservation, or the like, an UI element for displaying an alarm related to the above-mentioned mode setting, and the like.

A second sub-region 1430 displays a source supported by the display apparatus 1000 as the UI element. In this case, the controller 200 may separately display a source capable of providing an image and a source which does not provide the image. In addition, the controller 200 may dispose and display the UI elements for the sources to correspond to positions of a variety of ports disposed on a rear surface of the display apparatus 1000.

Although the case in which the UI elements are displayed on both the first sub-region 1420 and the second sub-region 1430 has been illustrated in the illustrated example, the UI elements may be displayed only on the first sub-region 1420 and may be displayed only on the second sub-region 1430, according to situations upon being implemented.

According to an exemplary embodiment of the present disclosure, the controller 200 may determine a sub-region on which the UI is to be displayed, among the plurality of sub-regions based on the position of the user.

The controller 200 may detect the position of the user using at least one sensor. Here, it is assumed that the sensor is a photographing element (e.g., a camera or the like), and an operation of sensing the position of the user will be described with reference to FIG. 15.

The camera 380 may be disposed in a position at which the front surface of the display apparatus 1000 may be photographed, and may generate a photographed image according to a preset period unit or a control request of the controller.

The controller 200 may sense the user from the generated photographed image and may sense the position of the sensed user. For example, in a case in which the user is sensed at a right side of the photographed image, it may be sensed that the user is positioned at the right side based on the display apparatus, that is, a left region of the screen.

Meanwhile, hereinabove, although only the case in which the position of the user is sensed using the camera has been described, the position of the user may also be sensed using a dedicated. An example thereof will be described with reference to FIG. 16.

In a case in which the motion sensor 400 includes an ultrasonic wave sensor, the ultrasonic wave sensor may be disposed on both ends of the flexible display 100. In addition, the ultrasonic wave sensor may reflect an ultrasonic wave in the front surface direction of the display apparatus 1000 at a timing in which a preset period or a preset event occurs. In addition, the ultrasonic wave sensor may receive the reflected ultrasonic wave to sense a distance and direction of the user.

When the position of the user is sensed by the method described above, the controller 200 may determine a sub-region on which an UI element corresponding to the sensed position of the user is to be displayed. For example, in a case in which the user is positioned at the left region of the screen, the gaze of the user is not a front, but a right side. Therefore, the user may conveniently view a sub-region 1720 of the right side rather than a sub-region 1730 of the left side. Therefore, in an event situation in which the menu is to be displayed, the controller 200 may display the corresponding menu on the sub-region 1720 of the right side. Alternatively, in a case in which the user is viewing the contents such as the movie, the controller 200 may display information such as a current running time for the corresponding contents on a sub-region 1820 of the right side. Similarly, in a case where the user is viewing a live television show or news, at least one of the sub-regions may display information from social media about a content of the show or news.

According to an exemplary embodiment of the present disclosure, the controller 200 may sense whether or not the user approaches the display apparatus. Specifically, the controller 200 may sense the position of the user in FIGS. 15 and 16 at the preset period unit, and may sense whether or not the user approaches the display apparatus using whether or not the position of the user enters within a preset range based on the display apparatus.

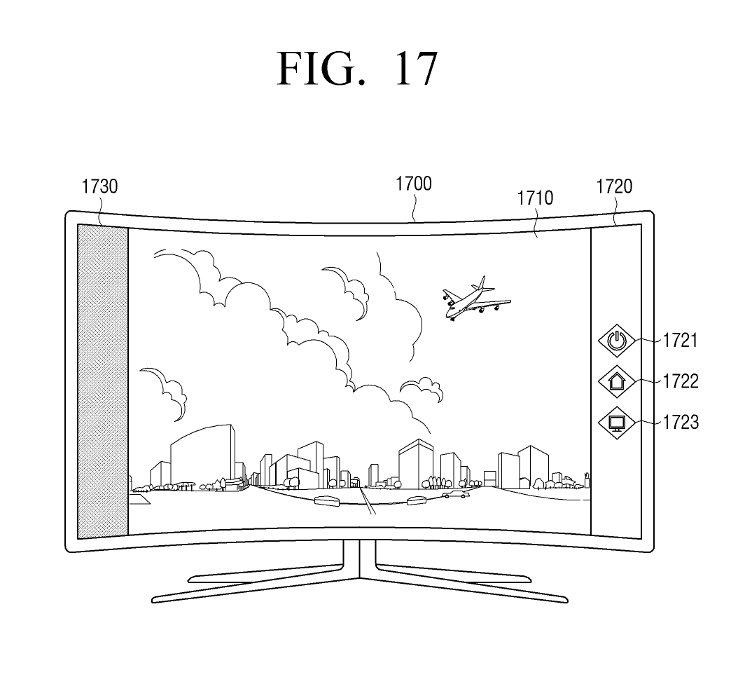

If it is determined that the user approaches the display apparatus 1000, the controller 200 may control the flexible display 100 so that menus 1721, 1722, and 1723 for controlling a basic function of the display apparatus are displayed on the first sub-region 1720, as illustrated in FIG. 17.

In this case, the controller 200 may also control the flexible display 100 so that another form of UI information is displayed according to an approach direction of the user. For example, if it is sensed that the user approaches the display apparatus 1000 from a right direction, the controller 200 may display the screen as illustrated in FIG. 17, and if it is determined that the user approaches the display apparatus 1000 from the left direction, the controller 200 may control the flexible display 100 so that the menu icons 1721, 1722, and 1723 described above are displayed on the second sub-region 1730.

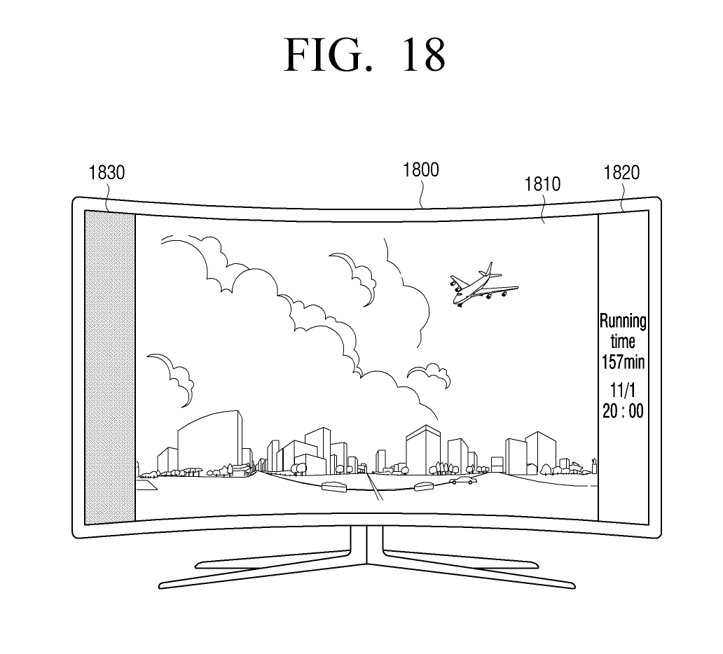

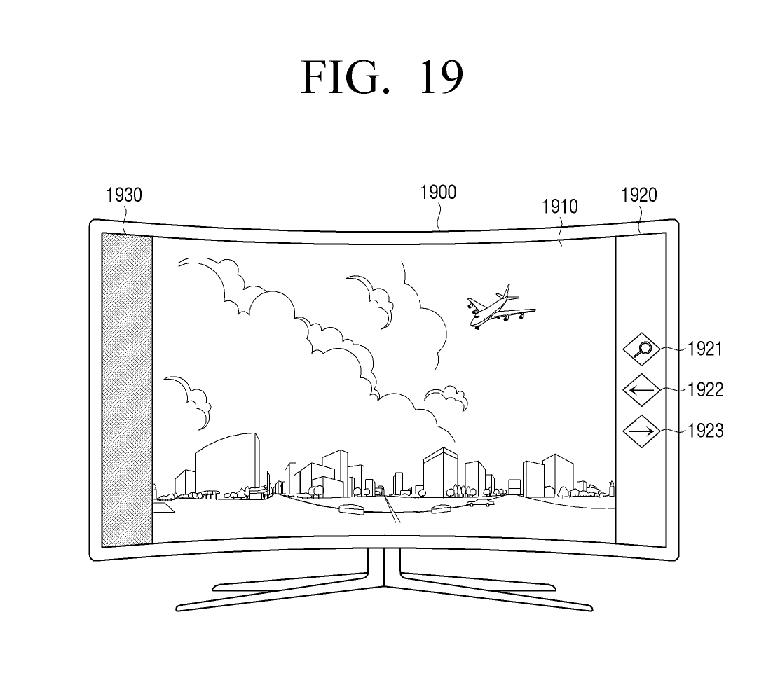

If it is sensed that the approaching user is away or far apart from the display apparatus, the controller 200 may make the menus disappear, may perform a control so that information (e.g., the content running time information, or the like) which is being previously displayed or menus 1921, 1922, and 1923 which are being previously displayed is displayed on the sub-region 1820 or 1920, as illustrated in FIG. 18 or 19, may cause the information displayed in the sub-region to be magnified so that the user can more easily see the information from a far distance, etc.

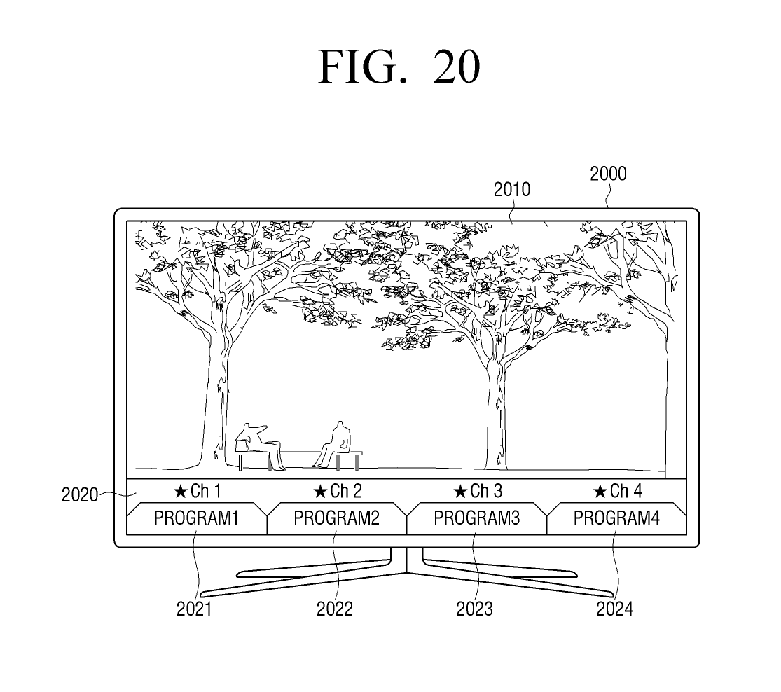

Although the case in which the sub-region is disposed at the left or right display region of the main region has been described, the sub-region may also be disposed on or below the main region, upon being implemented. A description of this example will be provided below with reference to FIGS. 20 to 22.

FIGS. 20 to 22 are various examples of the user interface window in a case in which a sub-region is disposed below a main region.

Referring to FIG. 20, the user interface window 2000 includes a main region 2010 and a sub-region 2020.

The main region 2010 is a region displaying an image of a channel which is pre-selected by the user (or contents which are pre-selected by the user).

The sub-region 2020 is a region displaying information of other channels (or contents which are similar to the contents which are pre-selected by the user). Specifically, the sub-region 2020 is a region displaying information on a channel 2021 which is pre-registered by the user and/or channels 2022, 2023, and 2024 in the front and the rear of the channel which is being displayed on the main region 2010. Although the case in which only program information of other channels is displayed has been illustrated in the illustrated example, a name and a current play state (i.e., whether or not an advertisement is displayed) of the corresponding program, a preview screen of the corresponding program, or the like may also be displayed.

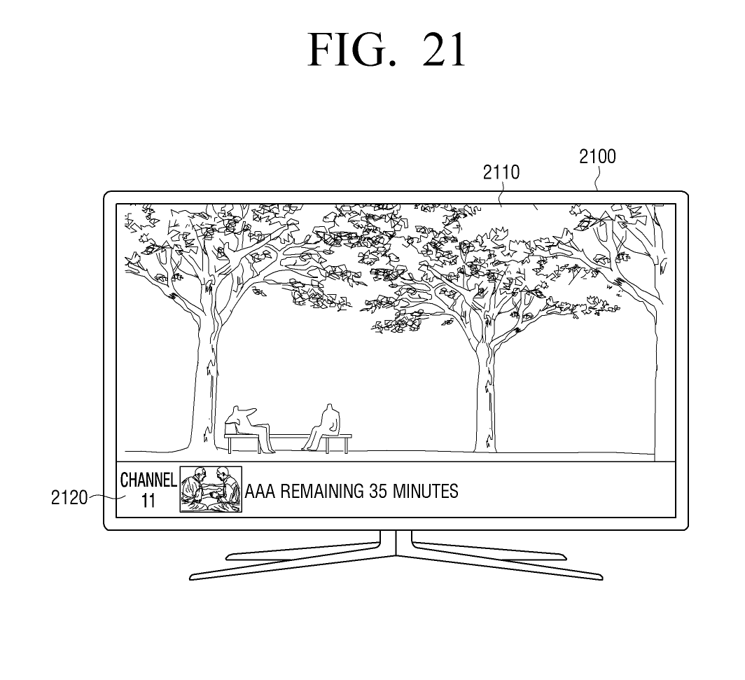

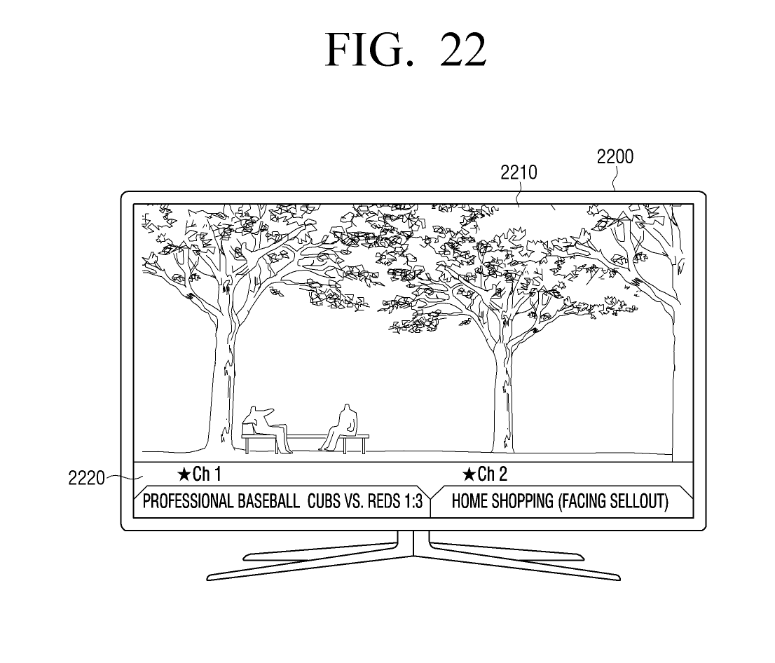

For example, if the user registers one channel 2021, a remaining play time of a pre-registered channel as illustrated in FIG. 21, score information in a case in which the pre-registered channel is a sporting event as illustrated in FIG. 22, a closing time in a case in which the pre-registered channel is a home shopping, and the like may be displayed. Whether or not the advertisement is broadcasted in the corresponding channel, ratings in real time, information of a PPL advertisement product in a current channel, a news flash, a subtitle in a current main channel, and the like, as well as the above-mentioned information may be displayed.

Although the case in which the sub-region 2020 is disposed only below the main region 2010 has been described, the sub-region 2020 may also be disposed on the main region 2010, and may also be disposed on both upper and lower regions of the main region 2010.

FIGS. 23 and 24 are examples of the user interface window which may be displayed in a case in which the user selects the smart home mode.

Referring to FIG. 23, the user interface window 2300 includes a main region 2310 displaying TV contents and a plurality of sub-regions 2320 and 2330.

The main region 2310 is a region displaying contents which are pre-selected by the user.

The first sub-region 2320 may display an operation state of the home appliances which may be controlled by the display apparatus or an event occurring from the corresponding home appliance as an icon. If an event message (e.g., a laundry completion message, a message indicating that a refrigerator door is opened over a preset time, a completion of the driving of the air conditioner, or the like) is received from a connectable home appliance, the first sub-region 2320 may display the received event message, or may also simultaneously display the received message on an icon corresponding to a washing machine while displaying the above-mentioned icon. Here, the home appliance may be apparatus connected to the home network, an apparatus which is directly connected to the display apparatus, an apparatus that forms a Bluetooth connection with the display apparatus, and the like.

A second sub-region 2330 may not display a separate image.

Although the case in which the first sub-region 2320 and the second sub-region 2330 are disposed at the left/right sides of the main region 2310 has been displayed, sub-regions 2420 and 2430 may also be disposed on an upper or lower region of a main region 2410 as illustrated in FIG. 24.

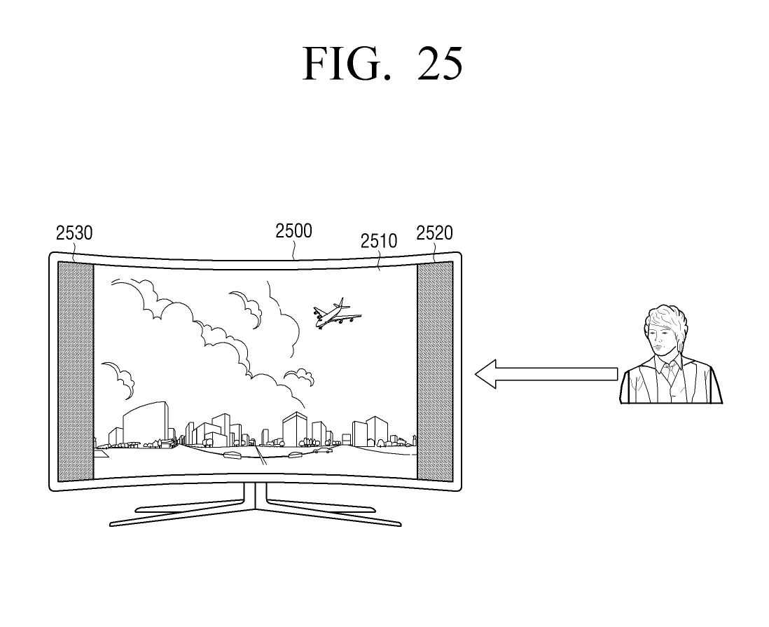

According to an exemplary embodiment of the present disclosure, the controller 200 may vary and display UI information in the sub-regions according to the approaching direction of the user and the gaze direction of the user. Specifically, as illustrated in FIG. 25, if it is determined that the user is positioned at a remote position, the controller 200 may not display any information on sub-regions 2520 and 2530.

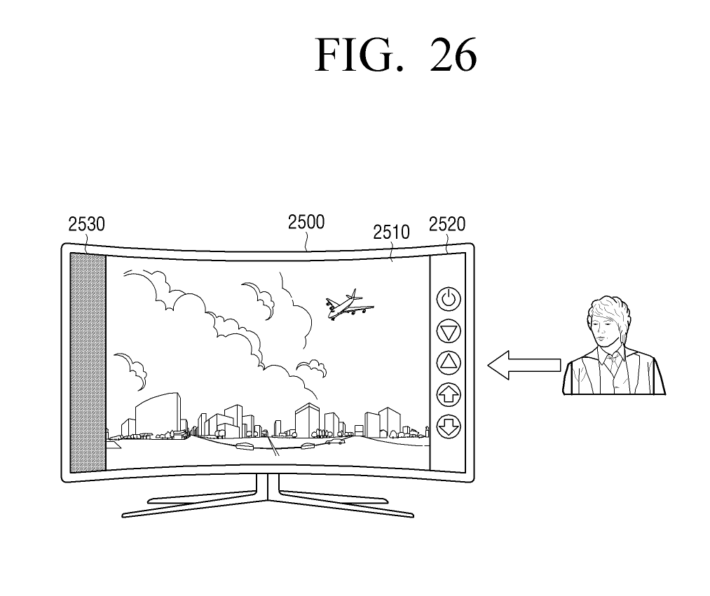

Thereafter, if it is determined that the user approaches the right region of the display apparatus, the controller 200 may detect the approaching of the user as the approaching for controlling a basic function (e.g., a power on/off, a volume up/down) of the display apparatus and may display an UI element for controlling the basic function on a sub-region 2520 of the right side as illustrated in FIG. 26.

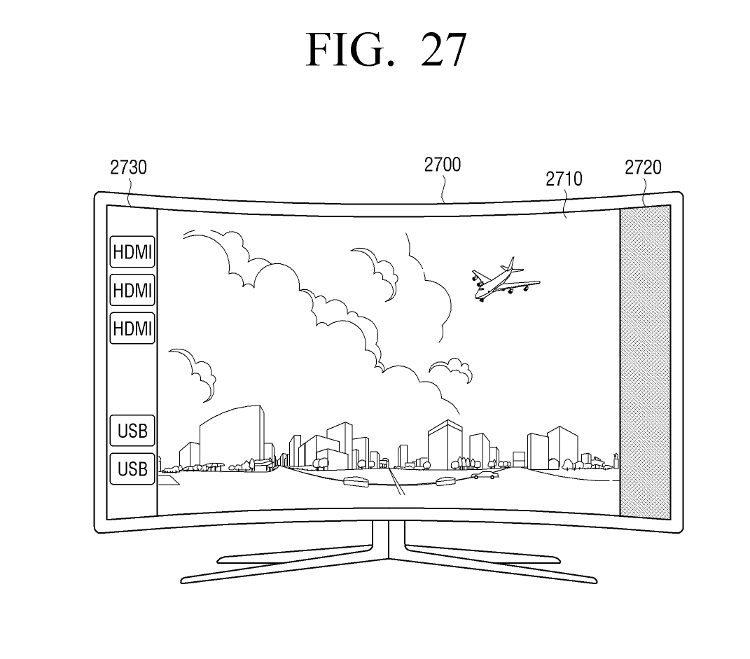

If it is determined that the user approaches the left region of the display apparatus, the controller 200 may detect the approaching of the user as the approaching for controlling a source (e.g., mounting and detaching USB, changing the source) of the display apparatus and may display an UI element for controlling the source on a sub-region 2730 of the left side as illustrated in FIG. 27.

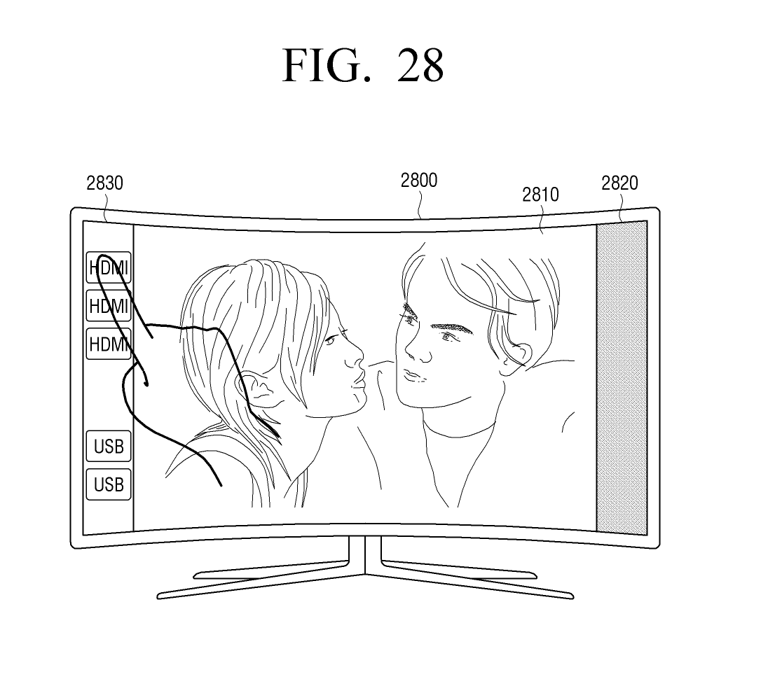

If the user selects a new source in a state in which the screen as illustrated in FIG. 27 is displayed, the contents displayed on a main region 2810 may be changed to the contents corresponding to the source selected by the user as illustrated in FIG. 28.

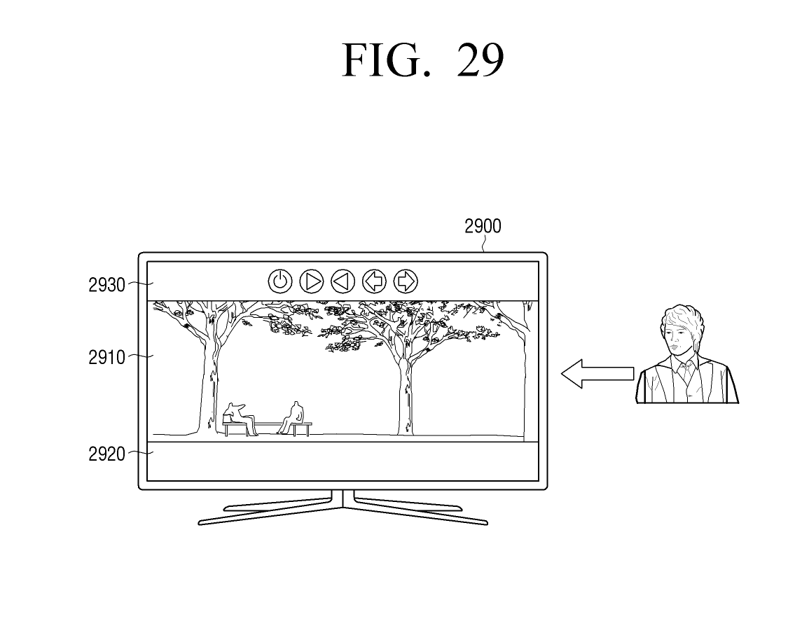

Although only the case in which the method of displaying the UI element is varied according to the approaching of the user to the display apparatus has been described, the UI element may be varied and displayed so as to correspond to the position or the gaze of the user upon being implemented. A description of this operation will be provided below with reference to FIGS. 29 to 31.

FIG. 29 is an example of a user interface window which may be displayed in a case in which a seated user stands up.

A user interface window 2900 includes a main region 2910 and sub-regions 2920 and 2930. The above-mentioned user interface window may be displayed in a case in which the user is sensed at a position which is a preset height or more.

The main region 2910 is a region displaying contents which are pre-selected.

An upper sub-region 2930 may display an UI element for performing a TV basic control in a case in which the stand up of the user is sensed.

A lower sub-region 2920 does not display a separate screen. Some regions of the contents displayed on the main region 2910 may be displayed. That is, the main region 2910 and the lower sub-region 2920 may also simultaneously display one content.

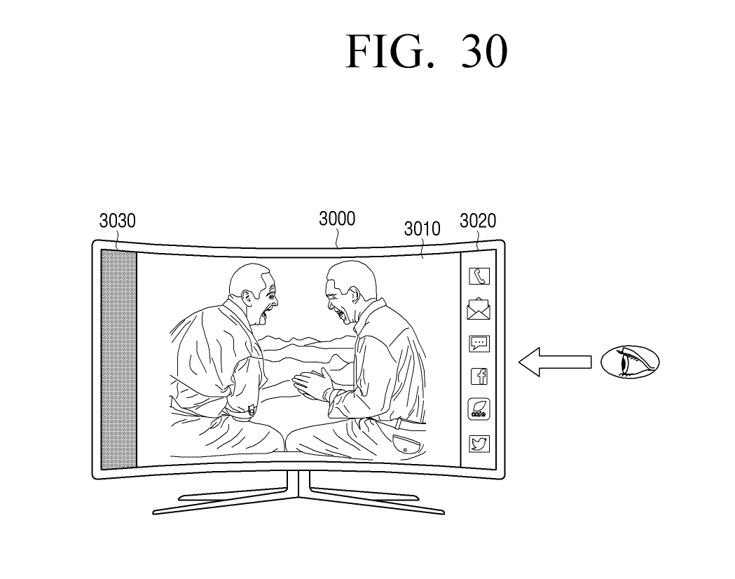

FIG. 30 is an example of a user interface window displaying an UI element for a control on a right sub-region 3020 of a right region of the main region in a case in which the gaze of the user is in a right direction.

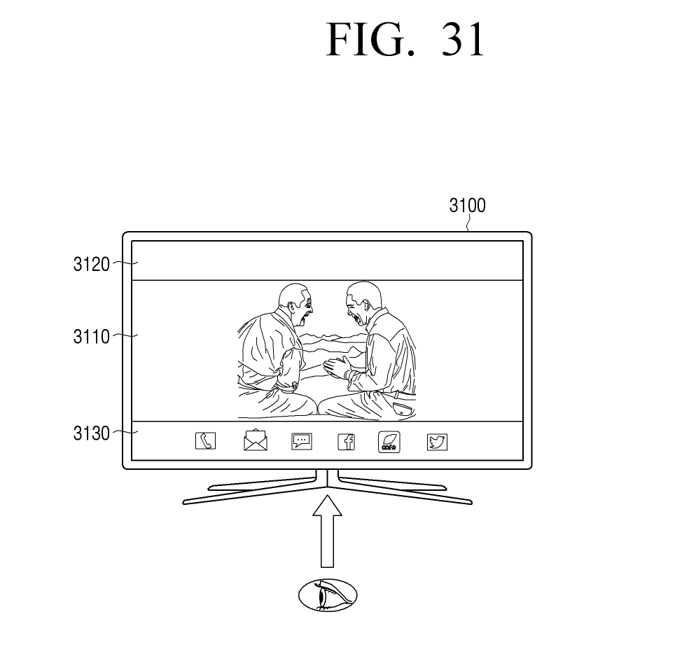

In addition, FIG. 31 is an example of a user interface window displaying an UI element for a control on a lower sub-region 3130 of a lower region of the main region in a case in which the gaze of the user is in a low end direction.

Meanwhile, the controller 200 according to the present exemplary embodiment may not display an image on the main region and may display the image only on the sub-region.

Specifically, in a case in which a music is played using the display apparatus 1000, or in a case in which the user does not directly view a TV, a display of a main screen may be stopped in order to save energy. For example, as illustrated in FIG. 32, the image may not be displayed on a main region 3210 and an UI element for receiving control instruction related to a playback of the corresponding contents may be displayed only on a sub-region 3220. The display of the screen as described above may be performed by a selection of the user, but may also be automatically performed if the user is not sensed by a sensor.

Some regions of the channel may display the image according to the operation described above, and waste of unnecessarily consumed power may be reduced, accordingly.

In addition, upon being implemented, when a preset time lapses after being changed to the screen as illustrated in FIG. 32, the image display on the sub-region may also be interrupted. Even in this case, if the approaching of the user is sensed or the preset event occurs, the screen as illustrated in FIG. 32 may also be displayed.

The controller 200 according to the present exemplary embodiment may simultaneously perform various applications. In addition, the controller may display the driven results of the respective applications. In this case, the driven application may be the application corresponding to the UI element on the sub-region, as described above with reference to FIG. 11. For example, if the user selects an Internet retrieval icon displayed on the sub-region of FIG. 11, the display apparatus 1000 may display retrieval contents by an Internet retrieval on a sub-region 3320 while displaying image content for a TV image on a main region 3310.

Meanwhile, in a case in which the display region of the retrieval contents is large, since the retrieval contents may cover the screen of the basic image contents, the controller 200 according to the present exemplary embodiment may display the image contents for the TV image on a main region 3410 and may display the retrieval contents on a sub-region 3420 as illustrated in FIG. 34.

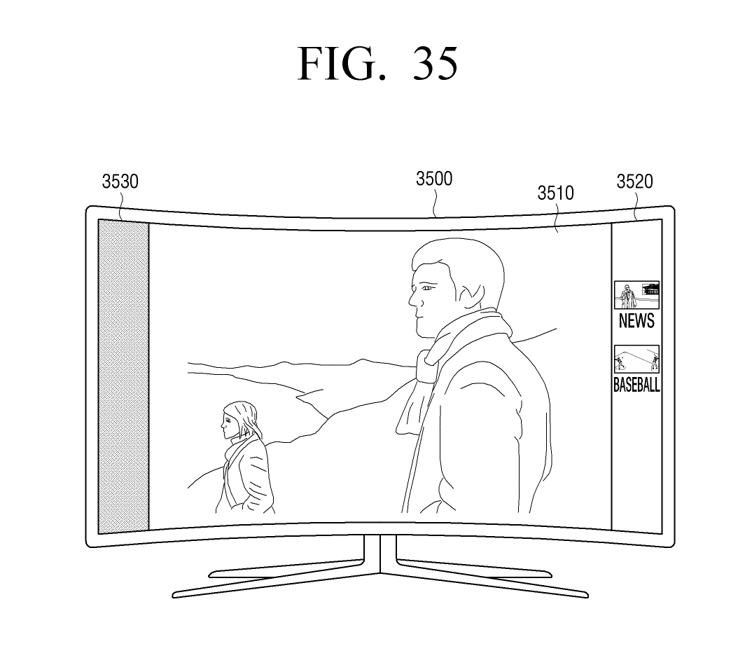

In addition, as illustrated in FIG. 35, the controller 200 may also display a thumbnail image of image contents of other channels as well as different kinds of applications on a sub-region 3520. In this case, even though the screen displayed on the main screen is not changed, the user may easily check states of other channels. For example, if an advertisement is being displayed before a specific broadcasting A, the user waiting the specific broadcasting A may easily check whether or not the advertisement of the specific broadcasting A is terminated even though the user does not change the screen of a main region 3510.

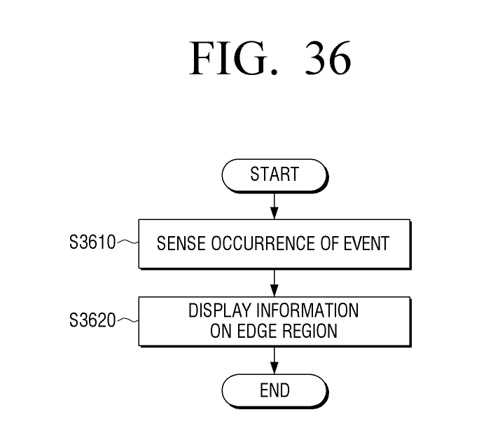

FIG. 36 is a flow chart illustrating a display method in a display apparatus including a flexible display according to various exemplary embodiments of the present disclosure.

First, an occurrence of an event is sensed (S3610). Specifically, whether events such as the approaching of the user to the display apparatus, an input of manipulation instruction of the user by a control terminal such as a remote controller, a reception of an alarm message by the other terminal, and the like occur may be sensed. Whether or not the flexible display is in a flat state or a bent state may also be sensed together with the above-mentioned sensing. The above-mentioned sensing may be performed using a separate sensor (e.g., a sensor sensing whether or not the panel is positioned on the edge region of the body unit 110, or a sensor capable of sensing arrangement forms of a center and both ends of the panel, and the like), or may be performed by checking the operation state of the driver capable of changing the bent state of the flexible display 100.

If the specific event occurs, an UI element corresponding to the corresponding event is displayed on the sub-region (S3620). Specifically, if the events such as the approaching of the user to the display apparatus, the input of manipulation instruction of the user by the control terminal such as the remote controller, the reception of the alarm message by the other terminal, and the like occur, an icon and/or a message corresponding to the corresponding event may be displayed on the sub-region. In this case, if a plurality of sub-regions are present, the icon and/or the message may be displayed at a position in which the user may conveniently view, among the plurality of sub-regions by taking account of the position of the user or the gaze of the user.

In addition, if user selection instruction selecting one of the displayed UI elements is input, a function of an application corresponding to the selected UI element may be executed. For example, in a case in which the user approaches the display apparatus, a volume up icon may be displayed on the sub-region, and if the user touches the volume up icon, a volume up function for the contents which are being currently played may be performed.

According to the exemplary embodiments described above, the user may experience various user environments using the sub-region formed upon being bent.

The display method of the display apparatus according to various exemplary embodiments described above may be implemented in a program so as to be provided to the display apparatus. Particularly, the program including the display method of the display apparatus may be stored and provided in a non-transitory computer readable medium.

The non-transitory computer readable medium does not mean a medium storing data for a short period such as a register, a cash, a memory, or the like, but means a machine-readable medium semi-permanently storing the data. Specifically, various applications or programs described above may be stored and provided in the non-transitory computer readable medium such as a compact disc (CD), a digital versatile disk (DVD), a hard disk, a Blu-ray disk, a universal serial bus (USB), a memory card, a read-only memory (ROM), or the like.

Hereinabove, although the exemplary embodiments of the present disclosure have been shown and described, it should be understood that the present disclosure is not limited to the disclosed embodiments and may be variously changed by those skilled in the art without departing from the spirit and the scope of the present disclosure. Therefore, the present disclosure should be construed as including all the changes, equivalents, and substitutions included in the spirit and scope of the present disclosure.

1-23. (canceled)

24. An electronic apparatus comprising:
a display configured to include a curved main display area which is curved with a first curvature, a first curved auxiliary display area which is extended from the curved main display area to be bent on a first side of the curved main display area and is curved with a second curvature, and a second curved auxiliary display area which is extended from the curved main display area to be bent on a second side of the curved main display area and is curved with a third curvature; and
a controller configured to, in response to an occurrence of an event being detected while a content is provided on the curved main display area, control the display to maintain a state of providing the content on the curved main display area and provide information related to the event on at least one of the first curved auxiliary display area and the second curved auxiliary display area.

25. The apparatus as claimed in claim 24, wherein the second curvature is the same as the third curvature.

26. The apparatus as claimed in claim 25, wherein the second curvature and the third curvature are different from the first curvature.

27. The apparatus as claimed in claim 24, wherein a part of each of the first curved auxiliary display area and the second curved auxiliary display area region is curved with the second curvature and the third curvature, and at least a part of a remaining area includes a plane.

28. The apparatus as claimed in claim 24, wherein the event is a reception of an alarm message corresponding to an event or a state change occurring at an apparatus connected to a home network, and
the controller controls the display so that the alarm message is displayed on at least one of the first curved auxiliary display area and the second curved auxiliary display area.

29. The apparatus as claimed in claim 24, wherein the event is a command for driving a smart TV function, and
the controller controls the display so that a control icon for controlling TV content which is provided on the curved main display area is displayed on at least one of the first curved auxiliary display area and the second curved auxiliary display area.

30. A method of controlling an electronic apparatus comprising a display including a curved main display area which is curved with a first curvature, a first curved auxiliary display area which is extended from the curved main display area to be bent on a first side of the curved main display area and is curved with a second curvature, and a second curved auxiliary display area which is extended from the curved main display area to be bent on a second side of the curved main display area and is curved with a third curvature, the method comprising:
providing content on the curved main display area; and
in response to an occurrence of an event being detected while the content is provided on the curved main display area, maintaining a state of providing the content on the curved main display area and providing information related to the event on at least one of the first curved auxiliary display area and the second curved auxiliary display area.

31. The method as claimed in claim 30, wherein the second curvature is the same as the third curvature.

32. The method as claimed in claim 31, wherein the second curvature and the third curvature are different from the first curvature.

33. The method as claimed in claim 30, wherein a part of each of the first curved auxiliary display area and the second curved auxiliary display area region is curved with the second curvature and the third curvature, and at least a part of a remaining area includes a plane.

34. The method as claimed in claim 30, wherein the event is a reception of an alarm message corresponding to an event or a state change occurring at an apparatus connected to a home network, and
the providing the information related to the event comprises providing the alarm message on at least one of the first curved auxiliary display area and the second curved auxiliary display area.

35. The method as claimed in claim 30, wherein the event is a command for driving a smart TV function, and
the providing the information related to the event comprises providing a control icon for controlling TV content which is provided on the curved main display area on at least one of the first curved auxiliary display area and the second curved auxiliary display area.
